(19) United States
(12) Patent Application Publication
(10) Pub. No.: US 2008/0300984 A1
(43) Pub. Date: Dec. 4, 2008

(54) METHODS AND APPARATUSES RELATED TO THE OFFER OF PURCHASE INCENTIVES

(76) Inventor: Lehmann Li, Studio City, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/129,646

(22) Filed: May 29, 2008

Related U.S. Application Data
(60) Provisional application No. 60/940,678, filed on May 29, 2007.
(60) Provisional application No. 61/020,118, filed on Jan. 9, 2008.

(51) Int. Cl. G06Q 30/00

(52) U.S. Cl. 705/14

(57) ABSTRACT

In one embodiment, a method includes receiving a customer identifier associated with a customer and receiving purchase data associated with the customer based on the customer identifier. The method can calculate a parameter value of a purchase incentive based on a financial condition and based on the customer identifier. The method can send the parameter value of the purchase incentive to a point of sale device in response to a transaction associated with the customer identifier.

### CROSS REFERENCE TO RELATED APPLICATIONS

The present application claims benefit of U.S. Provisional Patent Application No. 60/940,678, entitled “Systems, methods, apparatuses, and computer program products for enabling the offer of purchase incentives which increase incremental sales and profits,” filed on May 29, 2007 and U.S. Provisional Patent Application No. 61/020,118, entitled “Systems, methods, apparatuses, and computer program products for enabling the offer of purchase incentives which increase incremental sales and profits,” filed on Jan. 9, 2008, both of which are incorporated by reference in their entireties.

### BACKGROUND

Vendors offer customers coupons to buy their products. The means of implementing the coupons can vary, including, but not limited to: a retailer decreasing the unit price to any customer; a retailer offering one or more units of a product for free to any customer; a customer providing a retailer a coupon for redemption at the point of sale (POS); and/or a customer obtaining the benefit from the vendor after the sale in the form of a rebate.

An coupon can effectively decrease the unit price of the product sold. Unless coupons increase unit volume by a percentage large enough to offset the percentage decrease in unit price, total revenues will fall. Moreover, for certain products and/or at certain volumes, increasing unit volumes may not lead to lower and, in fact, can lead to higher marginal costs. So even if an coupon increases unit volume by a percentage to maintain total revenues, total profits can fall.

For example, assume a vendor sells 100 units at an unit price of $1.00 and an unit cost of $0.25 (which remains constant over the range considered), which generates total revenues of $100.00 and a total profit of $75.00. After offering an coupon reducing the unit price to $0.50, the vendor experiences a doubling of unit volumes to 200 units. Even though total revenues stay at $100.00, total profits fall to $25.00.

Given customer demand for the product and the cost structure of producing, distributing, marketing, and selling the product, there can be one or more number of unit sales and coupons which can increase profits of a vendor to a desired level. To determine the effect of customer demand on profits, a vendor needs to estimate the effect of price on customer demand for units. To determine the effect of the cost structure on profits, a vendor needs to estimate the total costs at different unit sales. The desired coupon will stimulate customers to buy an incremental number of units to a level which increases profits of the vendor to a desired level. In particular, the desired coupon will stimulate a customer to buy more units without subsidizing purchases which otherwise would have taken place.

If a vendor can offer to a customer an coupon and adjust the amount of the coupon so that the increase in unit sales will more than offset the decrease in unit price, then the vendor can enable an coupon to increase total revenues from sales to the customer. Moreover, if the vendor can include in an algorithm determining the desired coupon factors identifying the unit cost at various sales volumes, then the vendor can enable an coupon to increase total profits from sales to the customer.

Companies offering coupons face challenges along multiple dimensions in determining if any coupon leads a customer to buy more units than he/she otherwise would have bought without the coupon.

Along the time dimension, a customer who would ordinarily have purchased a product can delay the purchase of the same product until the coupon is available or accelerate the product purchase before the expiration of the coupon. If the coupon simply causes purchase deferral or acceleration, then the total revenues from the sale of the product to the customer will decrease because total unit sales did not change over a given time period.

Along the “space” dimension, a customer who would ordinarily have purchased a product at one Retailer can shift the same product purchase to another Retailer offering to redeem the vendor's coupon. If the coupon simply causes a shift in retail channel, then the total revenues accruing to the vendor offering the coupon from the sale of the product to the customer will decrease because unit sales from all Retailers did not change over a given time period. A customer can shift the same product purchase not only from one Retailer to another Retailer in one retail channel, e.g., Physical Retailer, but also from one retail channel to another retail channel, e.g., from Physical Retailer to Mail Order Retailer or Online Retailer.

Along the “person” dimension, a customer who would ordinarily have purchased a product can ask another person to buy the same product on his/her behalf utilizing an coupon. If the coupon simply causes the purchase to shift from one person to another, then the total revenues from the sale of the product will decrease because total unit sales from all customers did not change over a given time period.

To reduce or eliminate the effects of an coupon cannibalizing unit sales from shifts in purchase along one or more dimensions, a vendor can access data identifying the total unit sales of a product to a customer over any given time period across most, if not all, Retailers in different retail channels in different geographical locations.

### SUMMARY OF THE INVENTION

In one embodiment, a method includes receiving a customer identifier associated with a customer and receiving purchase data associated with the customer based on the customer identifier. The method can calculate a parameter value of a purchase incentive based on a financial condition and based on the customer identifier. The method can send the parameter value of the purchase incentive to a point of sale device in response to a transaction associated with the customer identifier.

### BRIEF DESCRIPTION OF THE DRAWINGS

The accompanying drawings, which are incorporated herein and form a part of the specification, illustrate the disclosed systems, methods, and apparatuses and, together with the description, further serve to explain the principles of the disclosed systems, methods, and apparatuses.

FIG. 1 depicts a block diagram of an exemplary data processing unit that can be used to implement the entities described herein.

FIG. 2 depicts a high-level block diagram of an exemplary system enabling any media device, e.g., a wireless device, to interact with content displayed on another media device and purchase or facilitate the purchase of a product promoted on another media device without exchanging data with the other media device, according to an embodiment.

FIG. 3 depicts a block diagram of an exemplary wireless device, according to an embodiment.

FIG. 4 depicts a block diagram of an exemplary system enable a wireless device and non-wireless device operated by the same user to interact with content displayed on another media device, according to an embodiment.

FIG. 5 depicts an exemplary customer product purchase database, according to an embodiment.

FIG. 6 depicts an exemplary Purchase Incentive parameters file, according to an embodiment.

FIG. 7 depicts a block diagram of an exemplary system enabling the collection and utilization of data to generate a Purchase Incentive which can increase Incremental Purchases and profits, according to an embodiment.

FIG. 8 depicts an exemplary customer lifetime value file, according to an embodiment.

FIG. 9 depicts an exemplary set of data which can enable the generation of customized Purchase Incentives, according to an embodiment.

FIG. 10 depicts an exemplary desired Purchase Incentive file, according to an embodiment.

FIG. 11 depicts an exemplary system for enabling the offer of a Purchase Incentive which can increase Incremental Purchases and profits, according to an embodiment.

FIGS. 12A and 12B depict a flowchart of an exemplary method for enabling the offer of a Purchase Incentive which can increase Incremental Purchases and profits, according to an embodiment.

FIG. 13 depicts a block diagram of an exemplary system enabling the collection of one or more customer IDs from a wireless device/non-wireless device user, according to an embodiment.

FIG. 14 depicts a flowchart of an exemplary method for enabling the collection of one or more customer IDs, according to an embodiment.

FIG. 15 depicts a block diagram of an exemplary system enabling the population of a data structure, e.g., a customer product purchase database, according to an embodiment.

FIG. 16 depicts a flowchart of an exemplary method for enabling the population of a data structure, e.g., a customer product purchase database, according to an embodiment.

FIG. 17 depicts a block diagram of an exemplary system enabling the exchange of data among a variety of data structures, e.g., a customer product purchase database, a customer database, and/or a price lookup table, according to an embodiment.

FIG. 18 depicts a flowchart of an exemplary method for enabling the exchange of data among a variety of data structures, e.g., a customer product purchase database, a customer database, and/or a price lookup table, according to an embodiment.

FIG. 19 depicts a block diagram of an exemplary system enabling the exchange of data among a variety of data processing systems to collect one or more payment IDs, according to an embodiment.

FIG. 20 depicts a block diagram of an exemplary system enabling the exchange of data among a variety of data processing systems to verify if a WD/NWD User purchased a product utilizing an electronic payment method, according to an embodiment.

FIGS. 21A and 21B depict a flowchart of an exemplary method for enabling the exchange of data among a variety of data processing systems to verify if a WD/NWD User purchased a product utilizing an electronic payment method, according to an embodiment.

FIG. 22 depicts an exemplary set of data structures which can enable the query of databases of one or more retailers to identify the purchase of a given product by a given customer, according to an embodiment.

FIG. 23 depicts a flowchart of an exemplary method for enabling the query of databases of one or more retailers to identify the purchase of a given product by a given customer, according to an embodiment.

FIG. 24 depicts a diagram of one or more devices in which data, e.g., an Ad ID or Product ID, can be stored, according to an embodiment.

### DETAILED DESCRIPTION

In some embodiments, a vendor can offer a customer a Purchase Incentive in response to an Advertisement displayed on any Media Device or independently of an Advertisement displayed on any Media Device. The incentives can take a variety of forms, including, but not limited to: a discount (partial or total) on the price of each unit; a volume discount; discounts (partial or total) on other products; discounts (partial or total) on related services (e.g., free shipping or delivery); financing subsidies; addition of product features at no or discounted cost; credit toward a future purchase (e.g., frequent flyer miles); points qualifying for a future purchase (e.g., a rewards program); and/or credit for qualifying in a sweepstakes (e.g., a purchase qualifying the customer to win a sweepstakes) (collectively, “Purchase Incentive”). A vendor can be any entity selling goods and/or services to customers. A vendor can include a retailer of goods and/or services.

In some embodiments, a vendor can offer a Purchase Incentive to generate a desired level of sales, incremental sales, and/or profits resulting from purchases utilizing the Purchase Incentive.

In some embodiments, a vendor and/or another entity can adjust dynamically the value of the Purchase Incentive based on one or more criteria specified by the vendor. The criteria can include, but are not limited to: any criteria relating the number of units available for purchase in the Purchase Incentive to the costs and profitability of the sale of the units.

In some embodiments, a vendor can offer a Purchase Incentive to limit the offer to a customer whose total unit purchases of the product exceeds the total unit purchases over any period specified by the vendor.

In some embodiments, a vendor can identify whether an Advertisement displayed in any advertising channel leads to a sale of the product promoted in the advertisement in any retail channel by utilizing a Purchase Incentive.

In some embodiments, a customer can realize the benefits of a Purchase Incentive requested without having to present the Purchase Incentive to a Retailer, which can encourage customers to request Purchase Incentives, avoid adding time to process coupon redemption at a Retailer, reduce the cost of processing paper coupons, reduce the cost to Retailers of delayed reimbursement for coupons, and eliminate errors of vendors reimbursement of coupons for non-qualifying product purchases.

In some embodiments, a retailer can remind a customer of Purchase Incentives previously saved or suggest to the customer products to purchase at the entrance to the store, instead of after a customer executes a transaction at the POS.

In some embodiments, people can view or listen to advertisements displayed on any media device by making Purchase Incentives available for only a limited time period after the advertisement terminates.

In some embodiments, an advertiser can pay for an advertisement only if it leads to an Incremental Purchase.

A Retailer can be any entity selling one or more goods and/or services. A Physical Retailer can be any Retailer selling goods and/or services in a physical location. An Online Retailer can be any Retailer selling goods and/or services through a data network, e.g., the Internet. A Mail Order Retailer can be any Retailer selling goods and/or services through exchange of information on paper, e.g., the mail. A Call Center Retailer can be any Retailer selling goods and/or services through a voice network.

### 1. Data Processing System

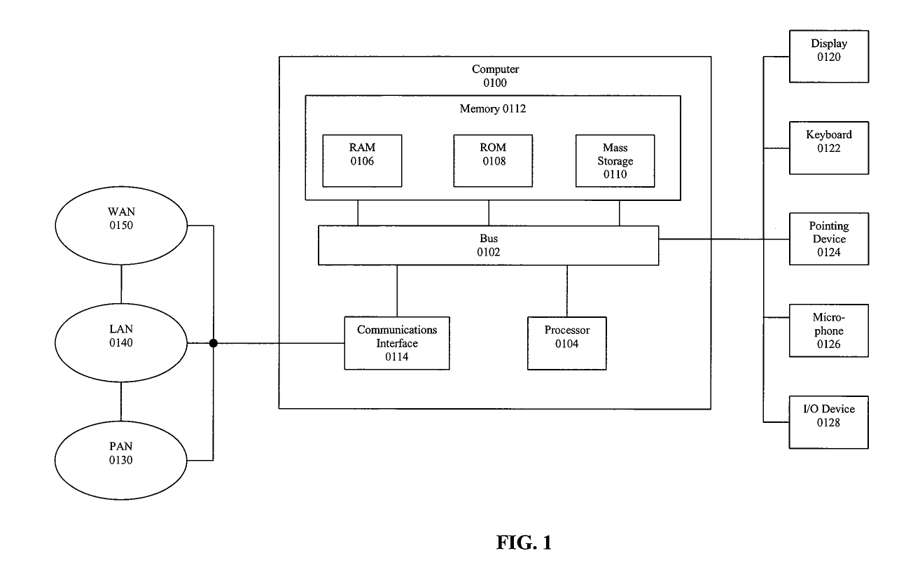

FIG. 1 depicts a block diagram of an exemplary Data Processing System 0100 that can be used to implement the entities described herein. The Data Processing System can implement the entities described herein using any number of components and the configuration actually used depends on the specific implementation.

Data Processing System 0100 can represent any type of device which can process data, including, but not limited to: a personal computer, a set-top box (STB), a portable computer, a hand-held computer, a personal digital assistant, a portable media device, a wireless device, a “smart card,” a server, a workstation, and/or a mainframe computer. The type of data processing system used to implement the entities described herein depends on the specific implementation.

Any of these devices can communicate with each other utilizing any protocol over any network, including, but not limited to: HyperText Transport Protocol (HTTP), file transport protocol (FTP), simple mail transport protocol (SMTP), post office protocol (POP), and/or Internet mail access protocol (IMAP) over a network, e.g., the Internet.

Data Processing System 0100 can comprise one or more components, including, but not limited to: any communications medium, wired and/or wireless (e.g., a Bus 0102), or any other means of transmitting and/or receiving data among components; a general- or special-purpose Processor 0104 or any other means of processing data; a random access memory (RAM) Device 0106 coupled to Bus 0102 capable of storing data and instructions executed by Processor 0104 or temporary variables or other intermediate data during the execution of instructions by Processor 0104; a read-only memory (ROM) Device 0108 coupled to Bus 0102 capable of storing data and instructions executed by Processor 0104; a Mass Storage Device 0110 (which can be a non-removable device, e.g., a hard disk drive, or a removable device, e.g., a floppy disk drive, a compact disc drive, a tape drive, a magneto-optical disc drive, or a chip, e.g., a chip as part of a subscriber identity module (SIM) card) coupled to Bus 0002 or Data Processing System 0100 capable of storing data and instructions executed by Processor 0104; a Display Device 0120 coupled to Bus 0102 or Data Processing System 0100 capable of displaying data to a computer user; a Keyboard or Keypad Device 0122 coupled to Bus 0102 or Data Processing System 0100 capable of communicating data and/or enabling command selection to Processor 0104; a Pointing Device 0124 coupled to Bus 0102 or Data Processing System 0100 capable of communicating direction information and/or enabling command selection to Processor 0104; a Microphone 0126 coupled to Bus 0102 or Data Processing System 0100 capable of communicating data and/or enabling command selection to Processor 0104; an I/O Device 0128 (which can enable any other type of input and/or output) coupled to Bus 0102 or Data Processing System 0100 capable of communicating direction information and/or enabling command selection to Processor 0104; and/or a Communications Interface 0114 coupled to Bus 0102 or Computer System 0100 capable of transmitting data to and/or receiving data from other Data Processing Systems through any type of network, including, but not limited to, a personal area network (PAN) 0130, a local area network (LAN) 0140, a metropolitan area network (MAN) (not pictured), and/or a wide area network (WAN) 0150, e.g., the Internet. Processor 0104 can reside at a single physical location or be distributed across a multiple physical locations, e.g., on one client and one server. Memory 0112 can include any device coupled to Bus 0102 capable of storing data and/or instructions executed by Processor 0104, including, but not limited to: RAM Device 0106, ROM Device 0108, Mass Storage Device 0110, a data cache, a data object, and/or any other type of short-term or long-term storage device. While prior art typically refers to memory and storage separately, memory can include storage. Memory 0112 can reside at a single physical location or be distributed across multiple physical locations.

The instructions can include code from any computer-programming language and/or scripts, including, but not limited to: C, C++, Basic, Java, JavaScript, Pascal, Perl, Smalltalk, Structured Query Language (SQL), VBScript, and/or Visual Basic. Communications Interface 0014 can include a modem, a network interface card, and/or any other device capable of coupling Data Processing System 0100 to any PAN 0130, LAN 0140, and/or WAN 0150. Communications Interface 0114 can include an antenna enabling wireless communication utilizing any wireless protocol with PAN 0130, LAN 0140 and/or WAN 0150. An Antenna can include any of the components necessary to transmit and/or receive an electromagnetic signal, e.g., a radio signal. Such components can include not only a physical material capable of conducting such a signal, but also any component which can perform any function needed to process such signal, including, but not limited to: modulation, demodulation, spreading, despreading, analog-to-digital conversion (ADC), digital-to-analog conversion (DAC), compression, decompression, upconversion, and/or downconversion. PAN 0130, LAN 0140 and/or WAN 0150 can enable communication through a wired, wireless, or combination of wired and wireless signals. Keyboard 0122 can include any device enabling an user of Data Processing System 0100 to input any alphanumeric character, including, but not limited to a Keyboard connected to a Personal Computer, and/or a Keypad connected to or integrated with a Wireless Device. An I/O Device is any device attached to and/or integrated with a Data Processing System 0100 which can enable such system to transmit data to and/or receive data from another device.

Data Processing System 0100 can implement any or all portions of the methods described herein through programmable logic, hard-wired logic, any combination of programmable and hard-wired logic, or any other type of logic. Control logic or software may be stored in Memory 0112 and/or computer program products. In one embodiment, Data Processing System 0100 can have one or more Processors 0104 execute one or more instructions stored in RAM 0106. RAM 0106 can retrieve the instructions from any other Computer/Machine Readable/Accessible Medium, e.g., Mass Storage 0110. In another embodiment, Data Processing System 0100 can have one or more Processors 0104 execute one or more instructions that are predefined or hard-wired. In another embodiment, Data Processing System 0100 can have one or more Processors 0104 execute one or more instructions utilizing a combination of programmable and hard-wired logic.

In one embodiment, the portions in any of the present methods are embodied in machine-executable instructions. The present methods can process instructions using one or more techniques, including, but not limited to: utilizing one or more general- or special-purpose processors programmed with the instructions to execute the steps in any of the present methods, equivalent or related steps, other or additional steps, or any subset thereof, utilizing one or more hardware components that contain hardwired logic to execute the steps in any of the present methods, equivalent or related steps, other or additional steps, or any subset thereof, or utilizing any combination of programmed processors and/or hardware components to execute the steps in any of the present methods, equivalent or related steps, other or additional steps, or any subset thereof. The software can execute on any type of hardware located at or distributed among one or more entities, including, but not limited to: an advertiser, a media buyer, a media operator, a media device, a wireless device, a retailer, or any third party.

In general, a “computer program product” can include any of the functions enabling the execution of the disclosed methods. When loaded in a Data Processing System 0100, in general, or a Computer/Machine Readable/Accessible Medium (e.g., processor-readable medium), in particular, a computer program product can execute the functions as described herein and cause a computer, general- or special-purpose processor, and/or other hardware to execute any of the steps described herein.

The computer- or machine-readable or -accessible medium can include, but is not limited to: floppy disks, magnetic disks, optical disks, magneto-optical disks, CD-ROMs, ROM, RAM, programmable read-only memory (PROM), erasable programmable read-only memory (EPROM), electrically erasable programmable read-only memory (EEPROM), magnetic or optical cards, or any other type of media or computer- or machine-readable or -accessible media capable of storing instructions (“Computer/Machine Readable/Accessible Medium”).

The functionality described herein can be distributed and/or downloaded as a computer program product. Methods described herein can be distributed from a remote computer, e.g., a server, to another computer, e.g., a client, through any wired and/or wireless channel over a network, e.g., the Internet.

### 2.1 Architecture of System

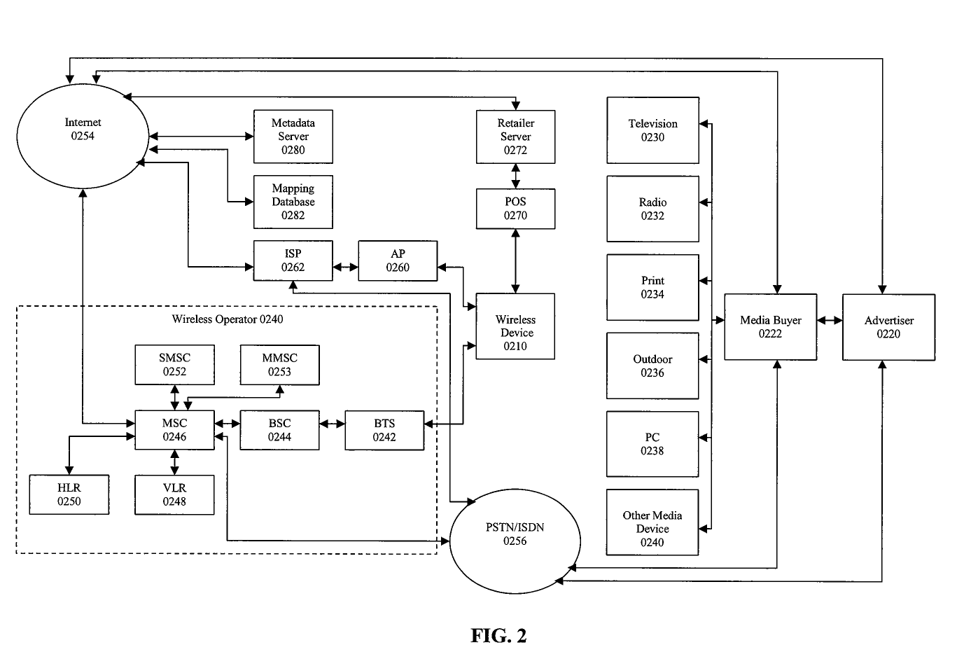

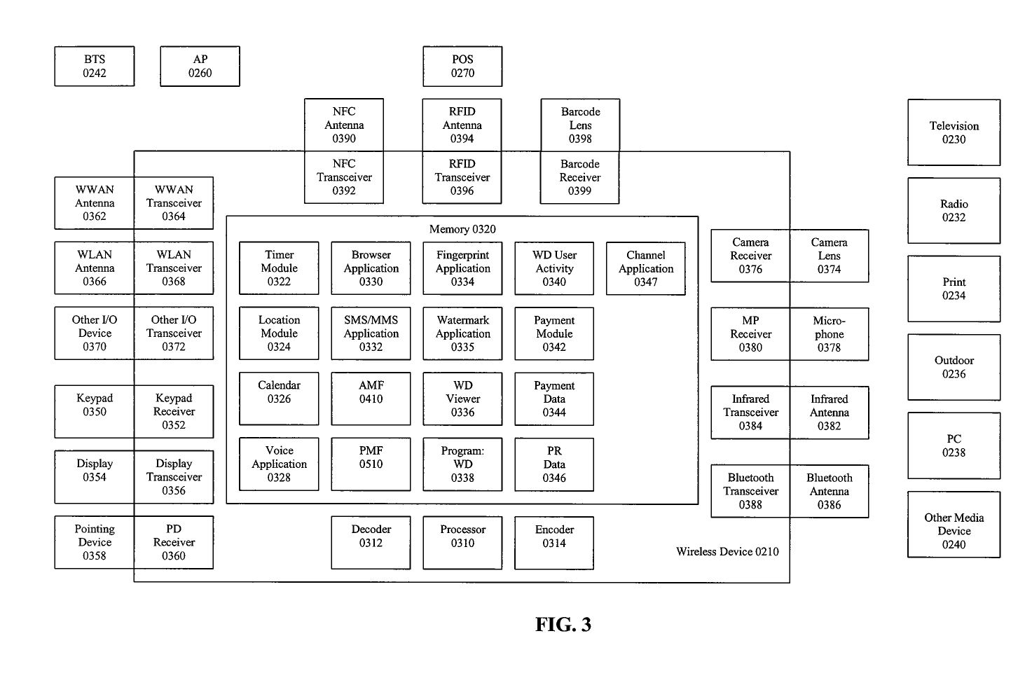

FIG. 2 illustrates a schematic block diagram of an exemplary system enabling any media device, e.g., a wireless device, to interact with content displayed on another media device. The system can utilize a subset of the following components, or additional, related, alternative, and/or equivalent components. The system can include, but is not limited to, the following components.

Wireless Device 0210 is a Data Processing System which can be configured to transmit and/or receive data wirelessly to and/or from other devices and which an user can transport (e.g., move) with him or her when the user changes geographical location. Exemplary Wireless Devices 0210 include, but are not limited to: a wireless phone, a portable computer, a personal digital assistant, an email device, a camera, a portable game player, a watch, a pager, or any device that combines one or more of these functions. Wireless Device 0210 can include one or more I/O Devices attached to or integrated with it that are capable of transmitting and/or receiving data wirelessly to and/or from one or more other devices.

Wireless Device 0210 can be configured to transmit and/or receive data wirelessly to and/or from any other device, including, but not limited to: Base Transceiver Station (BTS) 0242; Access Point 0260; and/or Point of Sale (POS) device 0270. Wireless Device 0210 can exchange data wirelessly with any other device through any type of network, including, but not limited to: a wireless PAN; a wireless LAN, a wireless MAN, and/or a wireless WAN. Wireless Device 0210 can exchange data wirelessly with any other device utilizing any protocol, including, but not limited to: 802.11; 802.15.3a or ultra wideband (UWB); 802.16; high performance radio metropolitan area network (HIPERMAN); wireless broadband (WiBro); 802.20; advance mobile phone system (AMPS); Bluetooth; code division multiple access (CDMA); CDMA2000; any extensions of CDMA2000; wideband CDMA (WCDMA); any extensions of WCDMA; digital video broadcasting-handheld (DVB-H); enhanced data rates for global evolution (EDGE); general packet radio service (GRPS); global system for mobile communications (GSM); high speed downlink packet access (HSDPA); HomeRF; infrared data association (IrDA); satellite digital multimedia broadcasting (S-DMB); terrestrial digital multimedia broadcasting (T-DMB); terrestrial integrated services digital broadcasting (ISDB-T); time division multiple access (TDMA); wireless IEEE 1394; wireless USB; and/or any equivalent or successor standards.

A Wireless Device 0210 can be configured, in some embodiments, to interact with content displayed on another Media Device and purchase or facilitate the purchase in any retail channel of a product promoted on another Media Device. Any Media Device configured based on the systems, methods, apparatuses, and computer programs described herein, can interact with content displayed on another Media Device and purchase or facilitate the purchase in any retail channel of a product promoted on the other Media Device.

Advertiser 0220 can be a Data Processing System which can perform a variety of functions, including, but not limited to: exchanging data with any other Data Processing System, including, but not limited to, Wireless Device 0210; Media Buyer 0222; mobile switching center (MSC) 0246; Internet Service Provider (ISP) 0262; Retailer Server 0272; Metadata Server 0280; and/or Mapping Database 0282. The data can include, but is not limited to: one or more Ad Metadata Files 0762; one or more Program Metadata Files 0764; and/or one or more Media Buy Schedules.

Advertiser 0220 can include a variety of components enabling the exchange of data with any other Data Processing System, including, but not limited to: a web server which can exchange data with any Media Device; and/or a Call Center which can communicate with one or more users of a Wireless Device 0210 through a voice communication.

Media Buyer 0222 can be a Data Processing System which can perform a variety of functions, including, but not limited to: exchanging data with any other Data Processing System, including, but not limited to: Wireless Device 0210; Advertiser 0220; MSC 0246; ISP 0262; Retailer Server 0272; Metadata Server 0280; and/or Mapping Database 0282. The data can include, but is not limited to: one or more Ad Metadata Files 0762; one or more Program Metadata Files 0764; and/or one or more Media Buy Schedules. Media Buyer 0222 can be operated by a media buyer, a media planner, an advertising agency, or any third party.

An Advertisement can be any information displayed on a Media Device promoting a product, brand, or vendor.

A Programming can be any information displayed on a Media Device which is not an Advertisement.

A Media Device (e.g., media processing device) can be any Data Processing System which can be configured to receive and display an Advertisement and/or Programming. A Media Device can be a Print 0234 and Outdoor 0236, even if it does not include one or more of the components constituting a Data Processing System. A Media Device can include, but is not limited to, the following Data Processing Systems:

Television 0230 is a Data Processing System which can comprise a variety of components, including, but not limited to: a set-top box (STB); a digital video recorder (DVR); and/or a display, e.g., a television screen. Television 0230 can perform a variety of functions, including, but not limited to: displaying an Advertisement and/or Programming; and/or transmitting and/or receiving data to and/or from another device, including a headend in the case of a cable television operator; a satellite in the case of a direct broadcast satellite television operator; an antenna in the case of a terrestrial television broadcaster; and/or a server in the case of an Internet television operator.

Radio 0232 is a Data Processing System which can perform a variety of functions, including, but not limited to: displaying an Advertisement and/or Programming; and/or transmitting and/or receiving data to and/or from another device, including an antenna in the case of a terrestrial radio broadcaster; and/or a satellite in the case of a direct broadcast satellite radio operator. While a Radio 0232 typically transmits an audio signal constituting an Advertisement and/or Programming and does not literally display an Advertisement and/or Programming, displaying can include the presentation of an Advertisement and/or Programming to an user of Wireless Device 0210 in any format, including, but not limited to, any form which the user can view, hear, touch, and/or smell.

Print 0234 is a publication printed on some form of paper. Print 0234 can include one or more I/O Devices capable of transmitting and/or receiving data to and/or from one or more I/O Devices. Print 0234 can display an Advertisement and/or Programming without one or more components constituting a Data Processing System. Exemplary Print 0234 include, but are not limited to: a newspaper; a magazine; and/or a package containing a product.

Outdoor 0236 is a Data Processing System which can perform a variety of functions, including, but not limited to: displaying an Advertisement and/or Programming; and/or transmitting and/or receiving data to and/or from another device through one or more I/O Devices. Outdoor 0236 can display an Advertisement and/or Programming without one or more components constituting a Data Processing System. Exemplary Outdoor 0236 include, but are not limited to: a billboard; a poster; and/or any electronic display outside a home or business.

Personal Computer 0238 is a Data Processing System which can perform a variety of functions, including, but not limited to: displaying an Advertisement and/or Programming; and/or transmitting and/or receiving data to and/or from another device through one or more I/O Devices.

Other Media Device 0240 is a Data Processing System other than a Television 0230, a Radio 0232, a Print 0234, an Outdoor 0236, or Personal Computer 0238 which can perform a variety of functions, including, but not limited to: displaying an Advertisement and/or Programming; and/or transmitting and/or receiving data to and/or from another device through one or more I/O Devices. Exemplary Other Media Devices 0240 include, but are not limited to: another Wireless Device 0210; and/or any other device capable of displaying an Advertisement and/or Programming.

Wireless Operator 0240 is any entity operating any type of wireless network, including, but not limited to: a wireless PAN, a wireless LAN, a wireless MAN, and/or a wireless WAN. Wireless Operator 0240 can utilize any wireless protocol, including, but not limited to: 802.11; 802.15.3a or UWB; 802.16; high performance radio metropolitan area network (HIPERMAN); wireless broadband (WiBro); 802.20; advance mobile phone system (AMPS); Bluetooth; code division multiple access (CDMA); CDMA2000; any extensions of CDMA2000; wideband CDMA (WCDMA); any extensions of WCDMA; digital video broadcasting-handheld (DVB-H); enhanced data rates for global evolution (EDGE); general packet radio service (GRPS); global system for mobile communications (GSM); high speed downlink packet access (HSDPA); HomeRF; IrDA; satellite digital multimedia broadcasting (S-DMB); terrestrial digital multimedia broadcasting (T-DMB); terrestrial integrated services digital broadcasting (ISDB-T); time division multiple access (TDMA); wireless IEEE 1394; wireless USB; and/or any equivalent or successor standards.

Wireless Operator 0240 network can include, but is not limited to, the following components.

BTS 0242 is a Data Processing System which can perform a variety of functions, including, but not limited to: exchanging data with one or more Wireless Devices 0210 and/or one or more base station controllers (BSC) 0244.

BSC 0244 is a Data Processing System which can perform a variety of functions, including, but not limited to: exchanging data with one or more BTS 0242 and/or one or more MSC 0246.

While the system includes a BTS 0242, a BSC 0244, and other components of a Wireless Operator 0240 network, the system is not limited to that embodiment. The system can support any components capable of exchanging data between one or more Wireless Devices 0210 and a Wireless Operator 0240, including, but not limited to, any equivalent or successor component to a BTS 0242, a BSC 0244, or any other component of a Wireless Operator 0240 network.

MSC 0246 is a Data Processing System which can perform a variety of functions, including, but not limited to: exchanging data with one or more BSC 0244; one or more visitor location registers (VLR) 0248; one or more home location registers (HLR) 0250; one or more short message service centers (SMSC) 0252; and/or one or more multimedia messaging service centers (MMSC) 0253. MSC 0246 can exchange a short message service (SMS) message between one or more Wireless Devices 0210 and one or more SMSC 0252. MSC 0246 can exchange a multimedia messaging service (MMS) between one or more Wireless Devices 0210 and one or more MMSC 0253. MSC 0246 can exchange data with any device over any type of network, including, but not limited to: a VLR 0248 over signaling system number 7 (SS7) or any other protocol, a HLR 0250 over SS7 or any other protocol; a SMSC 0252 over SS7 or any other protocol; a MMSC 0253 over SS7 or any other protocol; a WAN, e.g., the Internet 0254, over Internet protocol (IP); and/or a PSTN or integrated services digital network (ISDN) 0256 over any relevant voice and/or data protocols.

VLR 0248 is a database which can store temporary information about wireless subscribers who roam in the coverage area of a MSC 0246 with which VLR 0248 can communicate. VLR 0248 can be separate from, collocated with, or integrated with a MSC 0246.

HLR 0250 is a database which can store information about subscribers of a Wireless Operator 0240. MSC 0246 can request from HLR 0250 any information about subscribers to authenticate and register a given subscriber. HLR 0250 data can include, but is not limited to: the service profile, the location information, and/or activity status of a given subscriber.

SMSC 0252 is a Data Processing System which can perform a variety of functions, including, but not limited to: receiving, relaying, and/or storing and forwarding one or more short messages; interrogating a HLR 0250 for routing information; and/or transmitting a short message to the visited MSC 0246 of the recipient Wireless Device 0210. SMSC 0252 can exchange a short message with a Wireless Device 0210 and/or any other media device utilizing any protocol, including, but not limited to: SS7; and/or transmission control protocol/internet protocol (TCP/IP).

Internet 0254 is an exemplary WAN which can utilize any protocol, e.g., IP.

PSTN/ISDN 0256 is an exemplary WAN which can utilize any protocol, e.g., synchronous digital hierarchy (SDH), synchronous optical networking (SONET), and/or X.25.

A Wireless Operator 0240 or another entity, including, e.g., a Wireless Device 0210 user, can operate a wireless LAN enabling one or more Wireless Devices 0210 to exchange data with any other device. The wireless LAN can include, but is not limited to, the following components.

AP 0260 is a Data Processing System which can perform a variety of functions, including, but not limited to: exchanging data with one or more Wireless Devices 0210 and one or more ISPs 0262.

ISP 0262 is any entity operating a network enabling the exchange of data among two or more devices utilizing IP.

POS 0270 is a Data Processing System which can perform a variety of functions, including, but not limited to: receiving data through any type of I/O Device, including, but not limited to, a touch-sensitive Display 0120, a Keyboard 0122, a Pointing Device 0124, a barcode scanner, a radio frequency identification (RFID) reader, and/or a payment reader, e.g., a device enabling the input of data from a credit or debit account through any means; processing the data to execute a transaction involving the purchase of a product; and/or transmitting any data, e.g., a payment receipt recording the purchase of a product, to any device including, but not limited to, a Wireless Device 0210, and/or a Retailer Server 0272. POS 0270 can receive any data related to the purchase of a product, whether the data is in electronic- or non-electronic-form. POS 0270 can read electronic-based data, e.g., where an automobile dealer can input into a Personal Computer information about the user of a Wireless Device 0210. POS 0270 can read non-electronically-based data, e.g., where it can electronically scan a check written by an user of Wireless Device 0210.

Retailer Server 0272 is a Data Processing System which can perform a variety of functions, including, but not limited to: receiving data from one or more POS 0270; processing the data to perform a variety of functions, including, but not limited to, executing a transaction involving the purchase of a product, storing data about the transaction, product, and/or customer, querying databases about the transaction, product, and/or customer, and/or analyzing the data; and/or transmitting any data about one or more transactions, products, and/or customers. Retailer Server 0272 can be any entity capable of enabling the user of a Wireless Device 0210 to purchase a product, including, but not limited to: (a) a Physical Retailer, which is any entity that can sell a product at a physical location, examples of which can include, but are not limited to: a supermarket; a mass merchandiser; a drugstore; a dealer (e.g., an automobile dealer); a manufacturer (e.g., a company that owns and/or operates a store that sells products it manufactures); an outlet store; a vending machine; a kiosk; a store which can sell services; a financial institution (e.g., a bank branch or ATM); and/or a movie theater; (b) an online retailer; (c) a call center enabling the purchase of a product through a phone call; and/or (d) an entity which can enable the purchase of a product through transmission of a purchase order through a physical communications channel, e.g., mail-order.

Retailer Server 0272 can transmit to any entity data about one or more of the products it offers for sale. These data can include, but are not limited to: the description of a product; the availability of a product at any given Physical Retailer at any given time, e.g., not only the availability of a product, but the availability in any given size, color, material, or any other product feature; and/or the price of the product at any given Physical Retailer at any given time. Other devices can utilize the product data to enable the purchase of the product. These devices can include, but are not limited to: (a) Advertiser 0220 and/or Media Buyer 0222, which can import product availability, price, or any other product data into an Ad Metadata File 0762 and/or Program Metadata File 0764, e.g., an Advertiser 0220 promoting a movie can import data about the real-time availability of movie tickets at any given movie theater within the immediate geographical area of any given user of a Wireless Device 0210; and/or (b) Metadata Server 0280, which can import product availability, price, or any other product data into an Ad Metadata File 0762 and/or Program Metadata File 0764 to enable the user of a Wireless Device 0210 to view the real-time availability of any product promoted in an Advertisement and/or Programming.

Metadata Server 0280 is a Data Processing System which can perform a variety of functions, including, but not limited to: (a) receiving from Advertiser 0220 and/or Media Buyer 0222 any Ad Metadata File 0762, Program Metadata File 0764, Media Buy Schedule, and/or any other data enabling Metadata Server 0280 to identify an Advertisement and/or Programming of interest to a Wireless Device 0210 user; (b) storing any Ad Metadata File 0762, Program Metadata File 0764, and/or Media Buy Schedule in one or more databases; (c) updating any Ad Metadata File 0762 and/or Program Metadata File 0764 to reflect in real-time the description, availability, price, or any other data related to any product identified in an Ad Metadata File 0762 and/or Program Metadata File 0764; (d) receiving from Wireless Operator 0240 and/or ISP 0262 a request for one or more Ad Metadata Files 0762 and/or Program Metadata Files 0764; (e) processing the request for one or more Ad Metadata Files 0762 and/or Program Metadata Files 0764; (f) transmitting to Wireless Operator 0240 and/or ISP 0262 one or more Ad Metadata Files 0762 and/or Program Metadata Files 0764; (g) receiving from Wireless Operator 0240, ISP 0262, and/or Wireless Device 0210 a record of the action taken by the Wireless Device 0210 user in response to the reception of data in the Ad Metadata File 0762 and/or Program Metadata File 0764 (e.g., a Wireless Device User Response); (h) storing Wireless Device User Response data in a database; (i) analyzing the click-through rate (CTR) for one or more media operators to enable an Advertiser 0220 and/or Media Buyer 0222 to compare the CTR across different advertising channels; and/or (j) transmitting reports analyzing the effectiveness of any given advertising channel.

In addition, Metadata Server 0280 can be configured to, for example, act as a proxy server capable of performing as an intermediary between a client, e.g., a Wireless Device 0210, and another server (e.g., a Destination Server), which can include, but is not limited to: Advertiser 0220; Media Buyer 0222; Mapping Database 0282; and/or any third-party server. One or more Wireless Devices 0210 can establish connections to Metadata Server 0280, which can transmit to the Wireless Devices 0210 any data received from the Destination Server and/or data stored locally at Metadata Server 0280. Metadata Server 0280 can transmit to one of more Destination Servers any data received from one or more Wireless Devices 0210 and/or data stored locally at Metadata Server 0280.

Metadata Server 0280 can be configured to, for example, convert data: (a) received from one or more Wireless Devices 0210 in any messaging format or protocol, e.g., SMS, into data in another format or protocol, e.g., TCP/IP, which can be processed by one or more Destination Servers, e.g., a web server; and/or (b) received from one or more Destination Servers, e.g., a web server in any format or protocol, e.g., TCP/IP, into another format or protocol, e.g., SMS, which can be processed by one or more Wireless Devices 0210.

Metadata Server 0280 can present to one or more Wireless Devices 0210 dynamic content from one or more Destination Servers through a variety of means, including, but not limited to, the following. First, when receiving a request from one or more Wireless Devices 0210 for information about a product or data enabling the purchase of a product, Metadata Server 0280 can request from one or more Destination Servers any Dynamic Data, which is data that can change: (a) over the period of time when a Wireless Device 0210 can request information about a product or buy a product of interest; (b) depending on the location of a Wireless Device 0210 requesting information about a product or buying a product of interest; and/or (c) depending on the specific Wireless Device 0210 requesting information about a product or buying a product of interest.

In some embodiments, a Metadata Server 0280 can present to one or more Wireless Devices 0210 dynamic content from one or more Destination Servers by requesting from the Destination Server any Dynamic Data or periodically updating any Dynamic Data stored in Metadata Server 0280. In some embodiments, additional functions, including, but not limited to: (a) the caching at Metadata Server 0280 of any applications, executable code, documents, and/or any other data stored at one or more Destination Servers; and/or (b) the processing at Metadata Server 0280 or at one or more Wireless Devices 0210 any applications, executable code, documents, and/or any other data cached at Metadata Server 0280 can be performed.

In some embodiments, a Metadata Server 0280 can be configured to perform the above functions as a separate Data Processing System located separately from a Wireless Operator 0240, an Advertiser 0220, a Media Buyer 0222, or any other entity. The functions of Metadata Server 0280 can be executed at one or more Data Processing Systems co-located with, integrated with, and/or embedded in any Data Processing System that is part of a Wireless Operator 0240, an Advertiser 0220, a Media Buyer 0222, or any other entity. For example, the co-location of a Metadata Server 0280 with a MSC 0246, a VLR 0248, a HLR 0250, and/or any other Data Processing System operated by one or more Wireless Operators 0240 can be supported. In addition, the storage of the data in a Metadata Server 0280 and/or execution of the functions of a Metadata Server 0280 directly by a MSC 0246, a VLOR 0248, a HLR 0250, and/or any other Data Processing System operated by one or more Wireless Operators 0240 can be supported.

Mapping Database 0282 is a Data Processing System, which can include a database and can perform a variety of functions, including, but not limited to: receiving from Advertiser 0220 and/or Media Buyer 0222 any data related to the description, availability, pricing, or any other data related to a product identified in an Ad Metadata File 0762 and/or Program Metadata File 0764; receiving from one or more Retailer Servers 0272 any data related to the description, availability, pricing, or any other data related to a product identified in an Ad Metadata File 0762 and/or Program Metadata File 0764 and the geographical location of one or more Physical Retailers offering the product; receiving from one or more Wireless Devices 0210, Metadata Servers 0280, and/or any other device a request for data from Mapping Database 0282; processing the request by querying the Mapping Database 0282 to filter records of one or more products and/or Physical Retailers offering the product; and/or transmitting the query results.

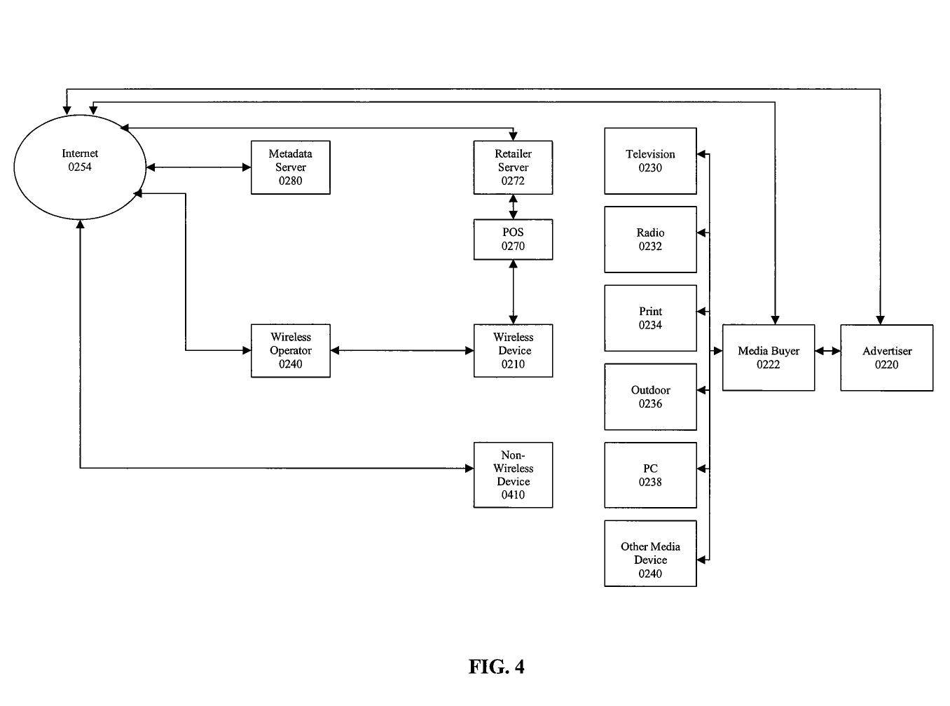

FIG. 3 depicts a block diagram of an exemplary wireless device. In some embodiments, the system can utilize a subset of the following components, or additional, related, alternative, and/or equivalent components. The system can include, but is not limited to, the following components.

Wireless Device 0210 can include a variety of other components not depicted in FIG. 3 which are typically required by a Wireless Device 0210 to receive, store, process, and/or transmit data, including, but not limited to, components capable of performing the following functions: modulation, demodulation, spreading, despreading, ADC, DAC, compression, decompression, upconversion, and/or downconversion. Wireless Device 0210 can include, but is not limited to, the following components capable of performing various functions.

Processor 0310 can be, for example, one or more general- or special-purpose Processor 0104.

Encoder 0312 can be, for example, one or more devices capable of encoding a signal into a format or protocol for transmission by one or more I/O Devices of Wireless Device 0210.

Decoder 0314 can be configured to, for example, decode the format or protocol of a signal received from one or more I/O Devices of Wireless Device 0210.

Memory 0320 can be configured to, for example, perform any of the functions of Memory 0112, including, but not limited to, storing any application and/or data in Wireless Device 0210.

Timer Module 0322 can be configured to, for example, record a date/time stamp associated with any event received or processed by a Wireless Device 0210 application.

Location Module 0324 can be configured to, for example, record the location of Wireless Device 0210 at the date/time of any event received or processed by a Wireless Device 0210 application.

Calendar 0326 can be configured to, for example, perform any function related to a calendar application.

Voice Application 0328 can be, for example, a computer program product can be configured to, for example, perform any function related to an application originating, processing, and/or terminating a voice communications by a Wireless Device 0210.

Browser Application 0330 can be configured to, for example, perform any function related to an Internet browser.

SMS/MMS Application 0332 can be, for example, a computer program product can be configured to, for example, perform any function related to a SMS or MMS application.

In addition, SMS/MMS Application 0332 can perform any function which can be performed by, for example, a sniffer program. The sniffer program can enable Wireless Device 0210 to intercept (e.g., receive) the transmission and/or reception of one or more SMS/MMS messages including data enabling the processing of any portion of the methods disclosed herein. By intercepting the SMS/MMS message, the sniffer program can pass the message to one or more applications, e.g., Program: WD 0338, instead of displaying the contents of the message on Display 0354 of Wireless Device 0210 for viewing by the user.

Fingerprint Application 0334 can be, for example, a computer program product that can be configured to, for example, perform any function related to recording a sample of any information signal, extracting a fingerprint from the sample, and/or searching for matching fingerprints in a fingerprint database.

Watermark Application 0335 can be configured to, for example, performing any function related to detecting a watermark from any information signal, and/or extracting any data embedded in the watermark.

WD Viewer 0336 can be configured to, for example, perform a variety of functions, including, but not limited to: receiving from Program: WD 0338 any data which Wireless Device 0210 can display on Display 0354; and/or transmitting to Program: WD 0338 any Wireless Device 0210 user action related to Display 0354.

Program: WD 0338 is a computer program product capable of performing a variety of functions, including, but not limited to: (a) reading any Ad Metadata File 0762 and/or Program Metadata File 0764; (b) extracting any value from Ad Metadata File 0762 and/or Program Metadata File 0764 and writing the value into: (i) any Wireless Device 0210 application, e.g., writing into Calendar 0326 a date/time and event description from an Ad Metadata File 0762 describing a future Television program promoted by the associated Advertisement, writing into WD Viewer 0336 any value from Ad Metadata File 0762 for display on Display 0354, writing into Browser Application 0330 the uniform resource locator (URL) from Ad Metadata File 0762, or writing into Voice Application 0328 the Phone Number from Ad Metadata File 0762; and/or (ii) any Wireless Device 0210 file, e.g., writing into WD User Activity File 0340 the Advertisement ID describing the associated Advertisement to which Wireless Device 0210 user is responding, or writing into Physical Retailer Data File 0346 the Purchase Incentive from Ad Metadata File 0762; (c) receiving from WD Viewer 0336 any Wireless Device 0210 user action related to Display 0354, including, but not limited to, User Identification Input, and/or User Response Input; and/or (d) storing in WD User Activity File 0340 one or more events received or processed by a Wireless Device 0210 application, including, but not limited to, the transmission of any URLs, the retrieval of any web pages, the transmission of any email addresses, the transmission of any SMS and/or MMS messages, the origination of any voice communications, the purchase of any products through Wireless Device 0210, the purchase from any retailers, whether online, Call Centers, or Physical Retailers, through Wireless Device 0210, the downloading of any content to Wireless Device 0210, and/or the downloading of any applications to Wireless Device 0210.

In addition to the above functions reading, storing, and/or writing data from and/or to any Wireless Device 0210 application and/or data file, Program: WD 0338 can process instructions and/or data to perform a variety of functions, including, but not limited to: (a) determining the collection of different type of data and/or amount of data desirable and/or required to identify the Advertisement and/or Programming of interest, functions described in more detail in Section 5.1.3; and/or (b) evaluating any data stored in WD User Activity File to identify an Advertisement and/or Programming to transmit to a Media Device in the vicinity of Wireless Device, functions described in more detail in Section 18.

Payment Module 0342 is a computer program product capable of performing a variety of functions, including, but not limited to: retrieving from Payment Data File 0344 any financial account data associated with the user of Wireless Device 0210; processing a transaction executed by any Wireless Device 0210 application, including, but not limited to, Voice Application 0328, Browser Application 0330, SMS/MMS Application 0332, and/or Program: WD 0338; and/or transmitting to any Data Processing System one or more records of transactions executed by any Wireless Device 0210 application.

Payment Data File 0344 can include any data describing one or more financial accounts associated with the user of Wireless Device 0210, including, but not limited to: any credit card account data; any debit card account data; any checking account data; any Internet payment account data; and/or any phone bill account data.

Physical Retailer Data File 0346 can include any data which Wireless Device 0210 can transmit to and/or receive from any I/O Device and/or Data Processing System located in a Physical Retailer. An user of a Wireless Device 0210 can interact with an Advertisement and/or Programming displayed on another Media Device and purchase or facilitate the purchase of the product promoted on the other Media Device in any retailer, including a Physical Retailer.

Media Device Channel Application 0347 is a computer program product capable of performing a variety of functions, including, but not limited to: reading from any signal or file data representing the channel to which another Media Device is tuned; processing the data to identify the channel; and/or transmitting the data to any other computer program product and/or Data Processing System. For example, in Section 5.1.1.6 a method of collecting data transmitted by a device capable of controlling a Media Device remotely (e.g., a Remote Control Device) to enable identification of the channel to which a Media Device controlled by the Remote Control Device is tuned is described. MD Channel Application 0347 can receive, process, and transmit the data.

Keypad 0350 can be configured to perform any of the functions of, for example, Keyboard or Keypad 0122. Keypad Receiver 0352 can be configured to receive data from, for example, Keypad 0350 and transmit the data to one or more components in, for example, Wireless Device 0210.

Display 0354 can be configured to perform any of the functions of, for example, Display 0120. Display Transceiver 0356 can be configured to exchange data between, for example, Display 0354 and one or more components in Wireless Device 0210.

Pointing Device 0358 can be configured to perform any of the functions of, for example, Pointing Device 0124. Pointing Device Receiver 0360 can be configured to receive data from, for example, Pointing Device 0358 and transmitting the data to one or more components in Wireless Device 0210.

WWAN Antenna 0362 can be configured to perform any of the functions of, for example, Communications Interface 0114 with respect to a wireless WAN, e.g., a typical cellular network. WWAN Transceiver 0364 can be configured to exchange data between, for example, WWAN Antenna 0362 and one or more components in Wireless Device 0210.

WLAN Antenna 0366 can be configured to perform any of the functions of, for example, Communications Interface 0114 with respect to a wireless LAN. WLAN Transceiver 0368 can be configured to exchange data between, for example, WLAN Antenna 0366 and one or more components in Wireless Device 0210.

Other I/O Device 0370 can be configured to perform, for example, any of the functions of Communications Interface 0114 with respect to any wireless network other than a wireless WAN or a wireless LAN. Other I/O Transceiver 0372 can be configured to, for example, exchange data between Other I/O Device 0370 and one or more components in Wireless Device 0210.

Camera Lens 0374 can be configured to, for example, receive one or more images, e.g., one still image or a plurality of images constituting a video. Camera Receiver 0376 can be configured to, for example, receive data from Camera Lens 0374 and transmitting the data to one or more components in Wireless Device 0210.

Audio Receiving Component 0378, e.g., a microphone, is a device capable of receiving audio signals. Audio Receiving Component Receiver 0380 is a device capable of receiving data from Audio Receiving Component 0378 and transmitting the data to one or more components in Wireless Device 0210.

Infrared Antenna 0382 can be configured to, for example, receive and/or transmit infrared signals. While Media Devices typically utilize an infrared light-emitting diode (LED) to transmit infrared signals, in some embodiments, an Infrared Antenna 0382 as including the capability of acting as an infrared LED is defined. Infrared Transceiver 0384 can be configured to, for example, receive data from Infrared Antenna 0382 and transmitting the data to one or more components in Wireless Device 0210 and/or receiving data from one or more components in Wireless Device 0210 and transmitting the data to Infrared Antenna 0382.

Bluetooth Antenna 0386 can be configured to, for example, perform any of the functions of Communications Interface 0114 utilizing the Bluetooth or similar protocol. Bluetooth Transceiver 0388 can be configured to, for example, exchange data between Bluetooth Antenna 0386 and one or more components in Wireless Device 0210.

NFC Antenna 0390 can be configured to performing any of the functions of Communications Interface 0114 utilizing the near field communications (NFC) or similar protocol. NFC Transceiver 0392 can be configured to, for example, exchange data between NFC Antenna 0390 and one or more components in Wireless Device 0210.

RFID Antenna 0394 can be configured to, for example, receive and/or transmit radio signals utilizing the RFID or similar protocol. RFID Transceiver 0384 can be configured to, for example, receive data from RFID Antenna 0394 and transmitting the data to one or more components in Wireless Device 0210 and/or receiving data from one or more components in Wireless Device 0210 and transmitting the data to RFID Antenna 0394.

Barcode Lens 0398 can be configured to, for example, receive and/or transmit a light source. Barcode Transceiver 0399 can be configured to, for example, receive a light source from Barcode Lens 0398, converting the optical signal into an electrical signal, and transmitting the data to one or more components in Wireless Device 0210 and/or receiving data from one or more components in Wireless Device 0210, converting the electrical signal to an optical signal, and transmitting the data to Barcode Lens 0398.

### 3.1 Data Structure

FIG. 5 depicts an exemplary Customer Product Purchase Database 0510. The data organization presented in FIG. 5 is not limited to that embodiment. The data can be organized in any other manner.

A Data Processing System storing Customer Product Purchase Database 0510 can receive any of the following types of data from any other Data Processing System, including, but not limited to: (a) Retailer Server 0272 which can transmit data on one or more products purchased by a customer; (b) any Data Processing System which can process data related to a purchase of a product by using a credit/debit card, e.g., Payment Card Interchange 2014 or Payment Card Issuer 2016; (c) Wireless Operator 0240 and/or any other Data Processing System related to a communications network which can enable the processing of a payment for a product; and/or (d) Wireless Device 0210 which can store data on the purchases executed with any component of Wireless Device 0210.

Customer Product Purchase Database 0510 can be any data structure including, but not limited to, the following types of data.

The Product ID field can include any data uniquely identifying a product, including, but not limited to: a standard code, e.g., the universal product code (UPC), the European article numbering (EAN) system, and/or the global trade identification number (GTIN); and/or a proprietary code utilized by an Advertiser 0220 and/or Media Buyer 0222. The data can be in any form, e.g., an alphanumeric string.

The Customer ID field can include any data which a Retailer Server 0272 can utilize to identify uniquely a customer who can be the Wireless Device 0210 user and/or a Non-Wireless Device 0410 user, including, but not limited to: a Shopper Loyalty ID; a Payment Method ID; one or more phone numbers utilized by Wireless Device 0210 user; and/or the name and/or address of Wireless Device 0210 user. Shopper Loyalty ID can be any code identifying the participation of a Wireless Device 0210 user and/or a Non-Wireless Device 0410 user in any type of shopper loyalty program, frequent shopper program, frequent flyer program, savings club, and/or any other type of program aimed at providing a customer discounts for buying products at a Retailer or from a vendor. While the term “shopper loyalty program” typically refers to a program aimed at providing discounts at a Physical Retailer, the term is not limited to that embodiment. Shopper Loyalty ID can be any code identifying a customer who can be the Wireless Device 0210 user and/or a Non-Wireless Device 0410 user in any program which can provide discounts to purchases at or from any entity, including, but not limited to: any type of Retailer, a vendor, and/or any other entity. The data can be in any form, e.g., an alphanumeric string.

Any disclosed method can uniquely identify a record in any disclosed database by, e.g.: (a) specifying any natural key as the primary key for one or more records in a database; and/or (b) specifying any surrogate key as the primary key for one or more records in a database.

Any disclosed method can utilize any type of data as the primary key for one or more records in any disclosed database, including, but not limited to, any of the data specified in the Customer ID field.

Payment Method ID can be any code identifying an user of a method of paying for a good or service offered by a vendor. The method can include, but is not limited to: any means enabled by a credit card vendor; any means enabled by a debit card vendor; any means enabled by a charge card vendor; and/or any means enabled by any other type of vendor which can pay for the purchase of one or more goods and/or services on behalf of the user. The method can include any method enabled by a vendor of a credit card, charge card, or any other type of card, including, but not limited to: a Retailer enabling the use of the method for purchases at its stores (e.g., a store-branded card); and/or any other entity enabling the use of the method for purchases at any Retailer. The method can be utilized in any type of retail channel, including, but not limited to: a Physical Retailer; an Online Retailer; a Mail Order Retailer; and/or a Call Center Retailer. For example, a Payment Method ID can be the code assigned to an user of a credit card, e.g., the code printed on the credit card. Instead of a Wireless Device 0210 user providing the entire Payment Method ID, the user can provide a subset of the Payment Method ID, e.g., the last four digits of a credit card number. Utilizing a Payment Method ID can help identify one or more products purchased by a consumer viewing an Advertisement displayed on any Media Device. Utilizing other data can complement a subset of the Payment Method ID to help identify the purchases by the consumer. The other data can include, but are not limited to: name; address; and/or phone number.

A variety of methods can write one or more values in the Customer ID field, including, but not limited to, the following. First, at setup or any subsequent time, Wireless Device 0210 user can input into Wireless Device 0210 one or more Customer IDs through a variety of methods, including, but not limited to: touching on a touch-sensitive Display 0354 one or more symbols or icons, which action can cause Display 0354 to transmit to one or more Wireless Device 0210 components the Customer ID, e.g., touching one or more virtual alphanumeric keys on Display 0354 to input one or more integers or letters; pressing one or more keys in Keypad 0350, which action can cause Keypad 0350 to transmit to one or more Wireless Device 0210 components the Customer ID; speaking into Microphone 0378 any data, e.g., one or more integers, letters, words, or phrases, which action can cause Microphone 0378 to transmit to one or more Wireless Device 0210 components the Customer ID; utilizing Barcode Lens 0398 and Barcode Receiver 0399 to read a barcode which encodes the Customer ID, which action can cause Barcode Receiver 0399 to transmit to one or more Wireless Device 0210 components the Customer ID; and/or utilizing Camera Lens 0374 and Camera Receiver 0376 to record an image of the printed Customer ID. Any method can store and/or transmit any data input into Microphone 0378 in raw format, e.g., 16 bit pulse code modulation (PCM).

For example, a Wireless Device 0210 user or a Non-Wireless Device 0410 user can utilize any digital camera, e.g., 0374 and 0376, to record an image of the Customer ID printed on one side of a Shopper Loyalty ID card issued by a Retailer and another image of the other side of the Shopper Loyalty ID card, which can include text and/or an image of the name of the Retailer (“Retailer ID Data”). Any method can record at least data identifying the Customer ID and the Retailer issuing the Shopper Loyalty ID card. If the camera is connected to or integrated with a Wireless Device 0210, the Wireless Device 0210 can utilize any method to store, process, and/or transmit the images of the Customer ID and Retailer ID Data to Metadata Server 0280, which can utilize any method to read, recognize, store, and/or process the images of the Customer ID into an alphanumeric code specifying the Customer ID encoded by the Shopper Loyalty ID card.

Second, at setup or any subsequent time, Non-Wireless Device 0410 user can input into Non-Wireless Device 0410 one or more Customer IDs through a variety of methods, including, but not limited to: touching on a touch-sensitive Display 0120 one or more symbols or icons, which action can cause Display 0120 to transmit to one or more Non-Wireless Device 0410 components the Customer ID, e.g., touching one or more virtual alphanumeric keys on Display 0120 to input one or more integers or letters; pressing one or more keys in Keyboard 0122, which action can cause Keypad 0122 to transmit to one or more Non-Wireless Device 0410 components the Customer ID; speaking into Microphone 0126 any data, e.g., one or more integers, letters, words, or phrases, which action can cause Microphone 0126 to transmit to one or more Non-Wireless Device 0410 components the Customer ID; utilizing a scanner to record a barcode which encodes the Customer ID and/or an image of the printed Customer ID, which action can cause the scanner to transmit to one or more Non-Wireless Device 0410 components the Customer ID; and/or utilizing a camera to record an image of the printed Customer ID, which the Non-Wireless Device 0410 user can transmit to one or more Non-Wireless Device 0410 components the Customer ID.

The benefits of utilizing as the Customer ID the data utilized by a Retailer Server 0272 to identify uniquely a Wireless Device 0210 user can include, but are not limited to, the following. First, utilizing data already utilized by a Retailer Server 0272 to identify a customer can obviate the need to assign a new code to identify a Wireless Device 0210 user or Non-Wireless Device 0410 user (“WD/NWD User”). Any disclosed system or method can: (a) utilize existing data utilized by Retailers; (b) utilize existing data identifying a Wireless Device 0210, e.g., a phone number, and/or a Non-Wireless Device 0410, an IP address; (c) generate new data identifying a Wireless Device 0210 and/or a Non-Wireless Device 0410; or (d) generate new data and then associating the new data with any other data in (a), (b), and/or (c). Because the system can associate and identify any purchases in a Retailer of a product promoted in an Advertisement and there are many legacy data structures utilized by Retailers, it can be easier to utilize existing data utilized by Retailers to identify a customer than to require Retailers to input new data identifying a customer already included in a Retailer customer database.

The Other ID field can include any data which a Retailer Server 0272 can utilize to identify uniquely a WD/NWD User other than a Shopper Loyalty ID, e.g., a Payment Method ID, and/or a phone number utilized by the WD/NWD User.

The Units Purchased field can include any data specifying the number of units purchased of the product identified by the Product ID during any Time Period. Any method can adjust the data in the Units Purchased field provided by different Retailers such that the data reflects the number of units purchased during the same Time Period. The data can be in any form, e.g., a numerical string.

The Retailer field can include any data identifying the Retailer providing any data associated with the Customer ID. Any data can uniquely identify a Retailer, which can include, but are not limited to: a standard code, e.g., a Merchant ID (MID) Number assigned to a Retailer by a payment processor; a GS1 Company Prefix making up part of the Global Trade Item Number (GTIN); any proprietary code; and/or the name and any other data which can unique identify a Retailer, e.g., an address or phone number of the headquarters. The data can be in any form, e.g., an alphanumeric string.

The Retailer Type field can include any data specifying the type of Retailer of the Retailer identified by the Retailer field. A single Retailer can operate multiple types of Retailers.

### 3.2 Customer Data Anonymity

Customer Product Purchase Database 0510 can utilize any data as a key for uniquely identifying a record. An embodiment can utilize the Customer ID. By utilizing the same data utilized by a Retailer Server 0272 to identify a customer, the embodiment can obviate the need to require Retailers to create a new key to identify uniquely a customer.

The embodiment does not require data which can identify the name or other personally identifiable information (PII) of the customer, Wireless Device 0210 user, and/or Non-Wireless Device 0410 user in order to associate the purchase of a product and the Advertisement which promoted the same product. For example, the embodiment can: (a) utilize the Customer ID to identify a customer in Customer Product Purchase Database 0510; and (b) assign the Customer ID to identify a Wireless Device 0210 and/or a Non-Wireless Device 0410 which transmitted an User Request in response to an Advertisement displayed by another Media Device. An User Request is any communication from a Wireless Device 0210 and/or a Non-Wireless Device 0410 which includes data requesting another Data Processing System, e.g., Metadata Server 0280, to execute any action, e.g., transmit to a Retailer or Wireless Device 0210 a Purchase Incentive. The embodiment can associate any purchase of the product in Customer Product Purchase Database 0510 with any viewing of an Advertisement promoting the product as identified by the User Request.

Another embodiment can utilize PII in Customer Product Purchase Database 0510, User Request, and/or any other data or database if the Wireless Device 0210 user, Non-Wireless Device 0410 user, and/or customer approve the use of PII.

### 3.3 Data Identification

### 3.4 Data Location

Many Retailers operate programs enabling them to obtain and analyze customer purchasing data, including, but not limited to: Shopper Loyalty programs; and/or proprietary and/or cobranded payment cards or devices.

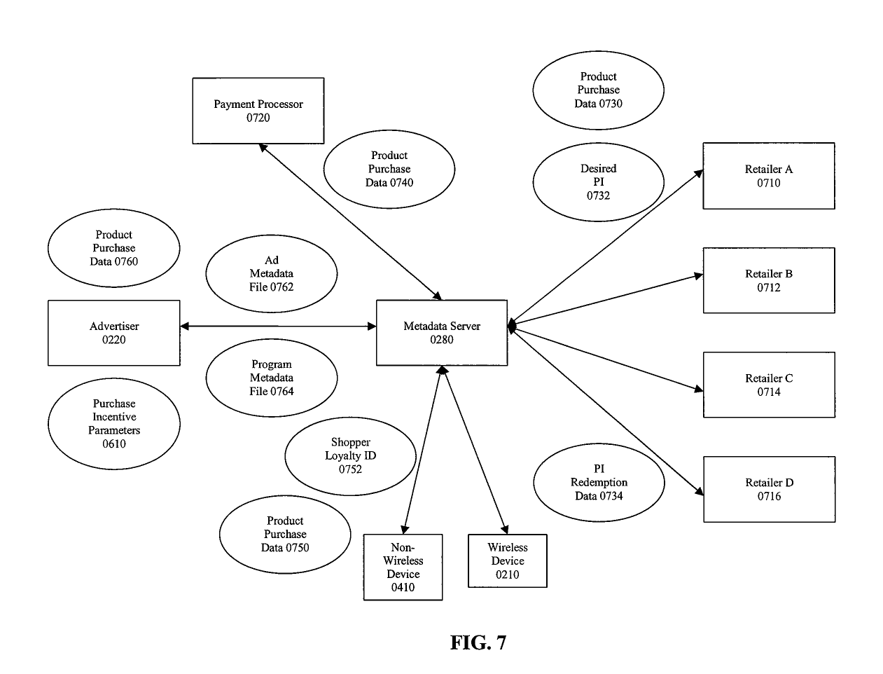

FIG. 7 depicts a block diagram of an exemplary system enabling the collection and utilization of data to generate a Purchase Incentive which can increase Incremental Purchases and profits. The system can utilize a subset of the following components, or additional, related, alternative, and/or equivalent components. The system can include, but is not limited to, the following components not disclosed earlier herein.

Retailer A 0710, Retailer B 0712, Retailer C 0714, and Retailer D 0716 can be a Retailer Server 0272 capable of performing a variety of functions, including, but not limited to: exchanging data with any other Data Processing System, including, but not limited to, Metadata Server 0280; Advertiser 0220; and/or Media Buyer 0222. The data can include, but are not limited to: one or more Product Purchase Data 0730; one or more desired Purchase Incentives 0732; and/or one or more Purchase Incentive Redemption Data 0734.

Payment Processor 0720 can be any Data Processing System capable of performing a variety of functions, including, but not limited to: exchanging data with any other Data Processing System, including, but not limited to, Metadata Server 0280; Advertiser 0220; and/or Media Buyer 0222. The data can include, but are not limited to: one or more Product Purchase Data 0740. Payment Processor 0720 can be any vendor enabling a Payment Method, e.g., a credit card vendor; a debit card vendor; a charge card vendor; and/or any other vendor capable of paying for the purchase of one or more goods and/or services on behalf of an user. While a Payment Processor 0720 may or may not have a record of the purchases of a customer at the level of an individual product identified by, e.g., an UPC, its records typically include data identifying the Retailer at which a customer purchased one or more goods and/or services. An Advertiser 0220 which is a Retailer can be interested in collecting data on a customer buying goods and/or services at a Retailer even if it does not collect data on the individual products purchased. Product Purchase Data 0740, which can include data identifying the Retailer but may not include data identifying the specific products purchased, can enable the generation of data showing the effectiveness of an Advertisement transmitted by an Advertiser 0220 which is a Retailer.

Product Purchase Data 0730 can be any data stored by a Retailer or any other entity associated with a product purchased by a customer. A Retailer typically stores data on the products purchased by a customer in a Customer Database, which can include a variety of data, including, but not limited to: a Customer ID, which can include any data a Retailer can utilize to identify uniquely a customer; the Units Purchased; the Time Period during which a customer can purchase any number of units; and/or the Product ID, which can include any data uniquely identifying a product, including, but not limited to, a standard code, e.g., the UPC, the EAN, and/or the GTIN; and/or a proprietary code utilized by the Retailer Server 0272.

Desired Purchase Incentive 0732 can be a generated Purchase Incentive which can increase Incremental Purchases and/or profit to a desired level. While the disclosed systems and methods can enable the generation of a Purchase Incentive which can increase Incremental Purchases and/or profit to a desired level, it is not limited to that embodiment. Systems and methods can enable the generation of any Purchase Incentive which an Advertiser 0220 and/or Media Buyer 0222 wishes to provide to a WD/NWD User.

Purchase Incentive Redemption Data 0734 can be any data transmitted by a Retailer Server 0272 and/or any other Data Processing System, e.g., Payment Processor 0720, indicating whether a customer purchased the product promoted in the Purchase Incentive within any requirements for volume, price, expiration, and/or any other criteria. Purchase Incentive Redemption Data 0734 can include, but are not limited to: the Customer ID; the Product ID of the product promoted in the Purchase Incentive; the number of units purchased; the price at which the customer purchased the product; and/or the date/time of the purchase.

Product Purchase Data 0740 can be any data stored by a Payment Processor 0720 associated with a product purchased by a customer and/or the Retailer at which the customer purchased a product.

Product Purchase Data 0750 can be any data stored by a Wireless Device 0210 and/or a Non-Wireless Device 0410 associated with a product purchased by a customer.

Shopper Loyalty ID 0752 can be one or more Shopper Loyalty IDs transmitted by Wireless Device 0210 and/or Non-Wireless Device 0410 to Metadata Server 0280.

Product Purchase Data 0760 can be any data stored by an Advertiser 0220 associated with a product purchased by a customer.

### 4. Generation of Desired Offer

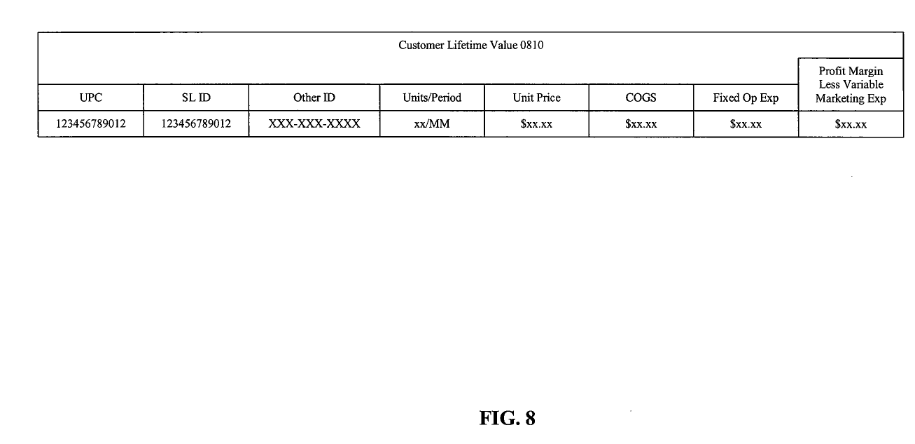

FIG. 8 depicts an exemplary customer lifetime value file.

The Customer Lifetime Value File 0810 can be any data structure comprising data including, but not limited to: (a) a primary key, e.g., a Shopper Loyalty ID, uniquely identifying a customer; (b) any data uniquely identifying a product, e.g., an UPC; (c) any data identifying the number of units of the product purchased by the customer over any given time period; (d) the unit price of the product; (e) the cost of goods sold (COGS) of the product; (f) any costs that are not variable that a vendor can allocate to the product; and/or (g) any type of profit margin of the product.

The data included in a data structure, e.g., the Customer Lifetime Value File 0810, can be used to generate a Purchase Incentive that increases customer lifetime value.

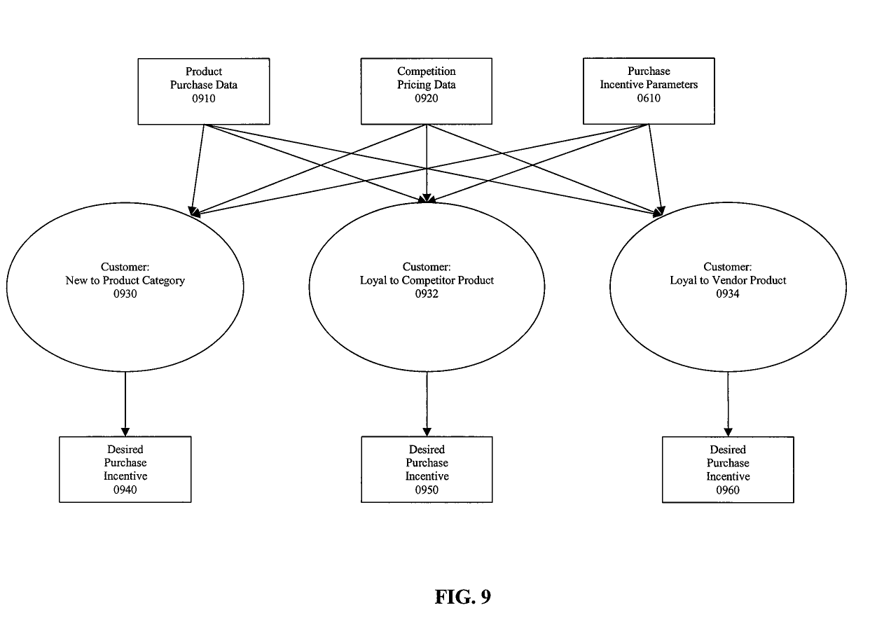

FIG. 9 depicts an exemplary set of data which can enable the generation of one or more customized Purchase Incentives. The exemplary data can include, but are not limited to: (a) Purchase Incentive Parameters 0610; (b) Product Purchase Data 0910, which can include, but are not limited to, any data in Product Purchase Database 0510; (c) Competition Pricing Data 0920, which can include, but are not limited to, any data related to prices of one or more vendors offering products directly and/or indirectly competing with the Vendor product of interest; (d) Customer: New to Product Category 0930, which can include data uniquely identifying a customer for which there does not exist data identifying the purchase of a product within a Product Category, as discussed in U.S. patent application Ser. No. 12/107,649 entitled, “Methods and Apparatus Related to Content Sharing Between Devices”; (e) Customer: Loyal to Competitor Product 0932, which can include data uniquely identifying a customer for which there exists data identifying one or more purchases of a product competing directly or indirectly with the Vendor product of interest; and/or (f) Customer: Loyal to Vendor Product 0934, which can include data uniquely identifying a customer for which there exists data identifying one or more purchases of the Vendor product of interest.

Any Data Processing System, e.g., Metadata Server 0280, can receive and/or store in Memory 0112 the data in Purchase Incentive Parameters 0610. For example, Advertiser 0220 can transmit to Metadata Server 0280 the parameters of a Purchase Incentive, including, but not limited to, the data in Purchase Incentive Parameters 0610.

Any Data Processing System, e.g., Metadata Server 0280, can receive and/or store in Memory 0112 the data in Product Purchase Data 0910. For example, one or more Retailers can transmit to Metadata Server 0280 data including one or more products purchased by a given customer.

Any Data Processing System, e.g., Metadata Server 0280, can receive from any Data Processing System and/or store in Memory 0112 the data in Competition Pricing Data 0920.

Any Data Processing System, e.g., Metadata Server 0280, can classify a customer in one of at least three categories, including, but not limited to: (a) the Customer: New to Product Category 0930; (b) Customer: Loyal to Competitor Product 0932; or (c) Customer: Loyal to Vendor Product 0934. The method of classifying a customer is not limited to the preceding embodiment and can extend to classifying a customer into a larger or smaller number of categories or different categories.

In a first embodiment, a Data Processing System, after receiving Product Purchase Data 0910, can query 0910 for any data uniquely identifying a product which is a subset of the Product Category. The Data Processing System can generate a data structure classifying each product to at least one Product Category. The Data Processing System can determine which Product Category to classify each product by utilizing any method, including, but not limited to, receiving from the Vendor of the product any data specifying the associated Product Category; and/or querying any data structure which associates any product with a Product Category. For example, Product Purchase Data 0910 can include a record of the customer purchasing a cereal brand identified by an unique product code, e.g., an UPC, which Metadata Server 0280 can classify in the Product Category “cereal” or “breakfast meal.” If the Data Processing System queries 0910 and does not identify any codes of products in a given Product Category, then the Data Processing System can classify the customer in Customer: New to Product Category 0930. If the Data Processing System queries 0910 and identifies one or more codes of products in a given Product Category, then the Data Processing System can classify the customer in either Customer: Loyal to Competitor Product 0932 or Customer: Loyal to Vendor Product 0934. If the Data Processing System identifies a number of codes of products produced by a Vendor above a predefined threshold, then the Data Processing System can classify the customer in Customer: Loyal to Vendor Product 0934. If the Data Processing System identifies one or more codes of products in a given Product Category and does not identify a number of codes of codes of products produced by a Vendor above a predefined threshold, then the Data Processing System can classify the customer in Customer: Loyal to Competitor Product 0932.

In a second embodiment, a Data Processing System, e.g., Metadata Server 0280, after receiving an User Request from a Wireless Device 0210 or a Non-Wireless Device 0410, can utilize any method to recognize the User Request and identify a product name included in the User Request. The Data Processing System can lookup any data structure which can include at least a Product ID and a Customer ID. If the User Request includes a Product ID, e.g., an UPC converted from a symbol, in general, or a barcode, in particular, then the Data Processing System can lookup the Customer ID associated with any data uniquely identifying the Wireless Device 0210 or Non-Wireless Device 0410. If the User Request does not include a Product ID but includes a product name, then the Data Processing System can lookup the Product ID associated with the product name and the Customer ID associated with any data uniquely identifying the Wireless Device 0210 or Non-Wireless Device 0410. After identifying the Product ID, the Data Processing System can transmit to any Retailer Server 0272 associated with the Customer ID a file including at least the Customer ID and a Product ID. Each Retailer Server 0272 can query a Customer Database for the record including the Customer ID and determine if the customer purchased the product identified by the Product ID and any other data related to the Product ID, e.g., the Units Purchased, and/or the Time Period during which the customer purchased any number of units (“Customer Product Purchase Data From Retailer”). Each Retailer Server 0272 can transmit to the Data Processing System, e.g., Metadata Server 0280, a file including Customer Product Purchase Data From Retailer. The Data Processing System can read the Customer Product Purchase Data From Retailer files from one or more Retailer Servers 0272 to determine if the Customer ID is associated with any Units Purchased of the Product ID. Utilizing any rule specifying a threshold of the number of Units Purchased for a given Product ID, the Data Processing System can classify a Customer ID into any category, e.g., Customer: New to Product Category 0930, Customer: Loyal to Competitor Product 0932, or Customer: Loyal to Vendor Product 0934.

After classifying a customer into a given category, the Data Processing System can utilize any other data, including, but not limited to, Purchase Incentive Parameters 0610, Product Purchase Data 0910, and/or Competition Pricing Data 0920, to generate a desired Purchase Incentive which is personalized for the customer and can achieve a desired level of sales, incremental sales, and/or profits resulting from purchases by the customer utilizing the Purchase Incentive.

In one embodiment, the Data Processing System can generate a desired Purchase Incentive for a given customer using the following function, Function 1.

Desired Purchase Incentive=[((Customer Product Awarenessᵢ)*w₁)+((Unit Priceᵢ (Manufacturer Suggested Retail Price, Retail Price)*w₂)+((Availability of Competing Productᵢ)*w₃)+((Customer: New to Product Categoryᵢ)*w₄)+((Customer: Loyal to Competitor Productᵢ)*w₅)+((Customer: Loyal to Vendor Productᵢ)*w₆)]

Customer Product Awareness is a variable which can have any value related to the degree to which the customer, in particular, or customers, in general, is aware of the product. The Data Processing System can input a value based on any method of measuring Customer Product Awareness, e.g., surveys of likely customers. The lower the Customer Product Awareness of a given product, the higher the value of a Desired Purchase Incentive an Advertiser 0220 is likely to require to encourage a customer to request the Desired Purchase Incentive.

The higher the Unit Price, the higher the value an Advertiser 0220 is likely to require to encourage a customer to request the Desired Purchase Incentive.

Availability of Competing Product is a variable which can have any value related to the degree to which a customer can obtain the benefits of a product from alternative products. If there are many competing products, an Advertiser 0220 is likely to require a higher value of the Desired Purchase Incentive to encourage a customer to request the Desired Purchase Incentive.

Customer: New to Product Category is a variable which can have any value related to the degree to which a customer has not previously purchased a product in the Product Category over a given time period. If the customer is new to the Product Category, an Advertiser 0220 is likely to require a higher value of the Desired Purchase Incentive to encourage a customer to request the Desired Purchase Incentive.

Customer: Loyal to Competitor Product is a variable which can have any value related to the degree to which a customer purchases a product in the Product Category which is not a product offered by the Advertiser 0220. If the customer is loyal to a competitor product, an Advertiser 0220 is likely to require a higher value of the Desired Purchase Incentive to encourage a customer to request the Desired Purchase Incentive.

Customer: Loyal to Vendor Product is a variable which can have any value related to the degree to which a customer purchases a product in the Product Category which is a product offered by the Advertiser 0220. If the customer is loyal to the vendor product, an Advertiser 0220 is likely to require a lower value of the Desired Purchase Incentive to encourage a customer to request the Desired Purchase Incentive.

The embodiment is not limited to the above function. The embodiment can implement the above function with different, additional, or fewer variables. For example, if classifying a customer to one or more categories is the factor most important in generating a higher rate of requests and/or redemptions, then it might not be necessary to include other variables in the above function.

In one embodiment, the Data Processing System can learn from prior events by adjusting the weights to reflect the more successful Desired Purchase Incentive parameters. That is, if one value of a Desired Purchase Incentive generated by a set of weights, w₁, w₂, w₃, w₄, w₅, and w₆, for a given set of Customer Product Awarenessᵢ, Unit Priceᵢ, Availability of Competing Productᵢ, Customer: New to Product Categoryᵢ, Customer: Loyal to Competitor Productᵢ, and Customer: Loyal to Vendor Productᵢ, generates a higher rate of requests and/or redemptions of a Purchase Incentive than other values of a Desired Purchase Incentive, the Data Processing System can adjust the set of weights to generate the value of the Desired Purchase Incentive to generate a higher rate of requests and/or redemptions for new customers.

### 4.1.1 Individual Customer Demand Data

### 4.1.2 Aggregate Customer Demand Data

6. Overall Method of Enabling Offers of Purchase Incentives which Increase Incremental Purchases and Profits

### 6.1 Overall Method

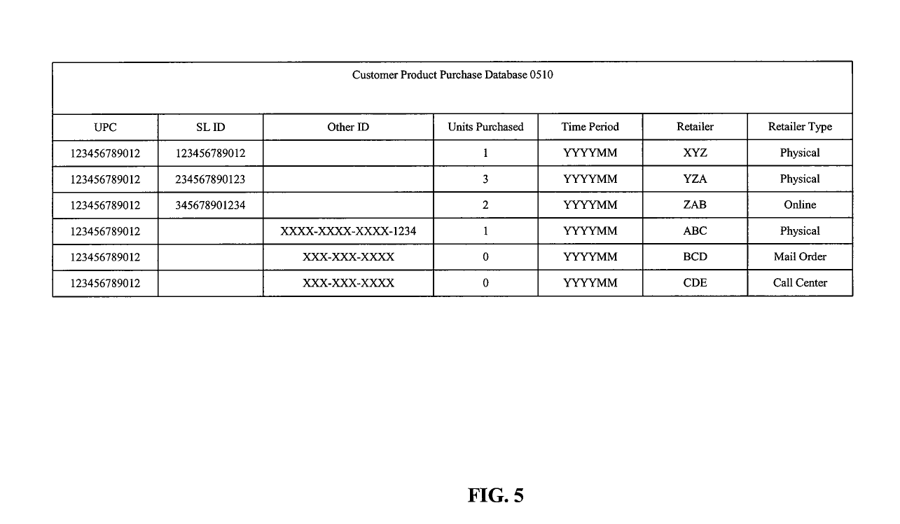

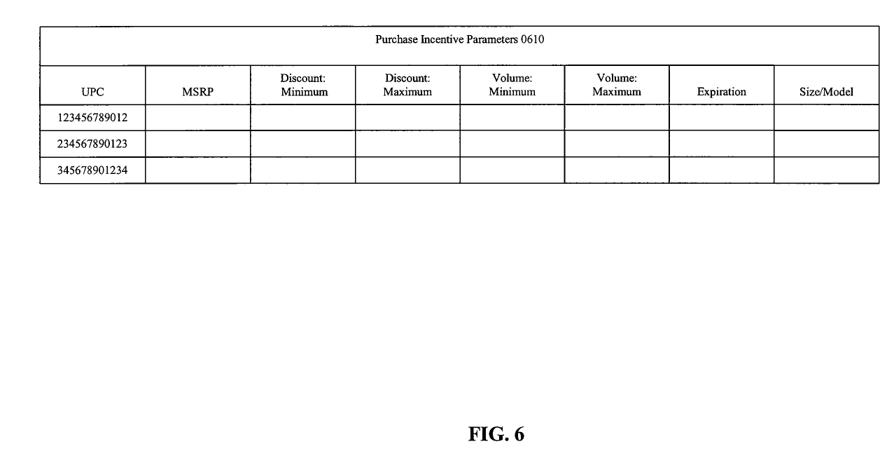

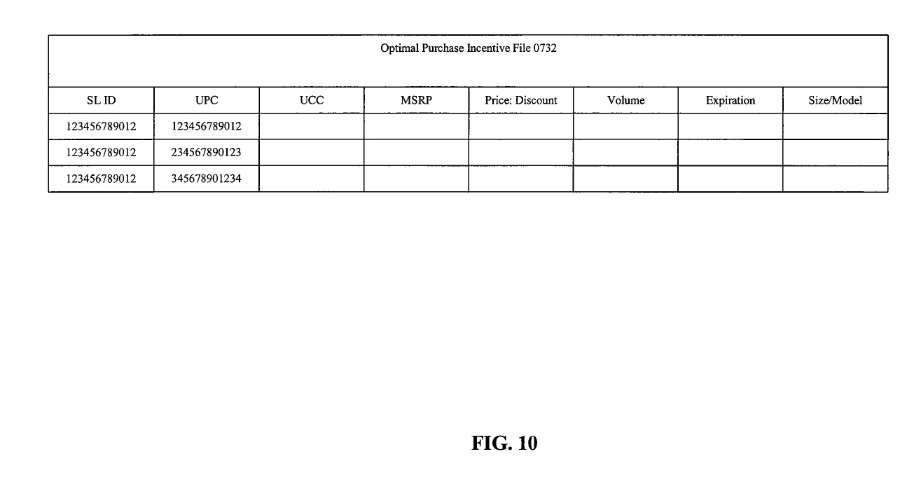

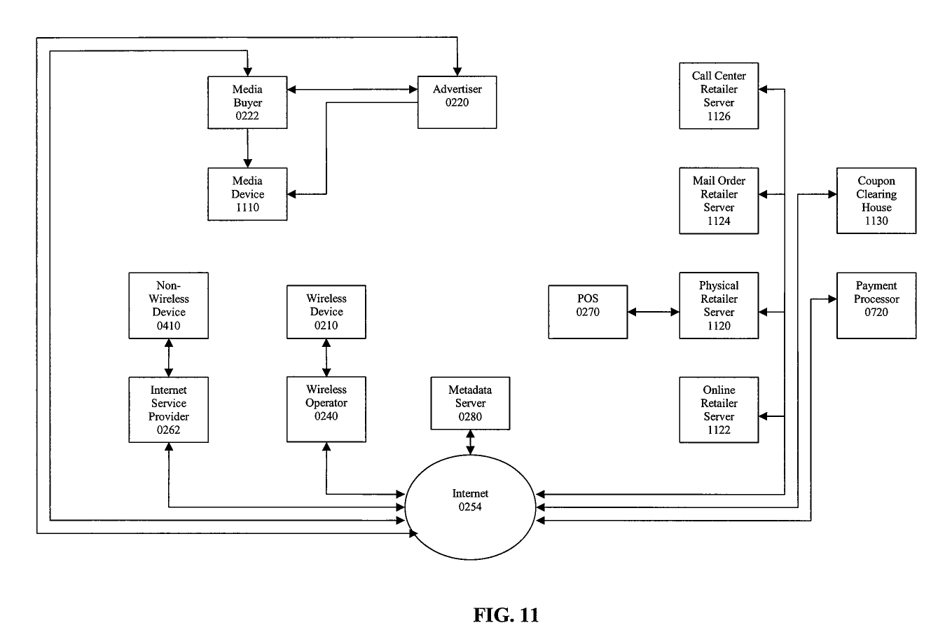

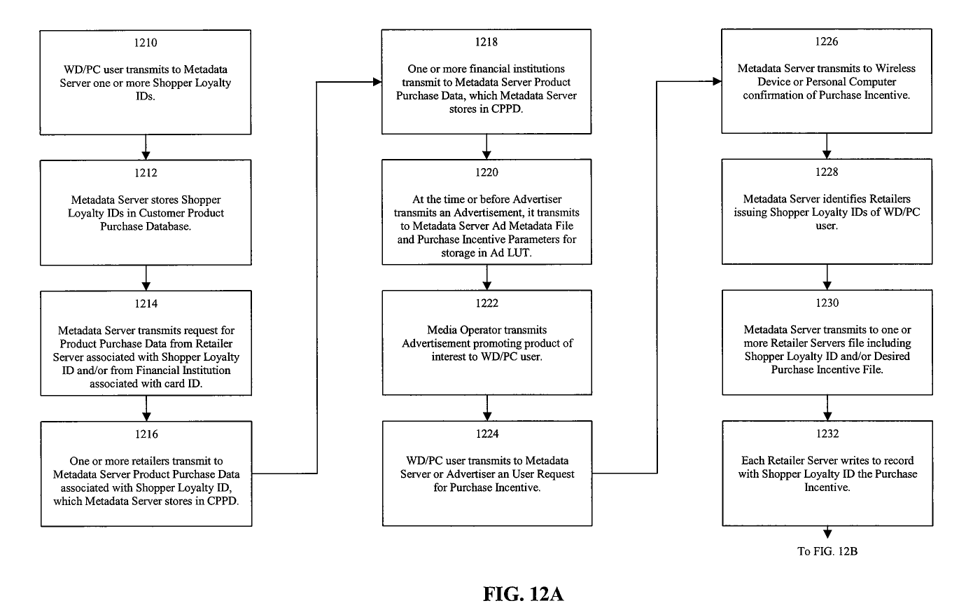

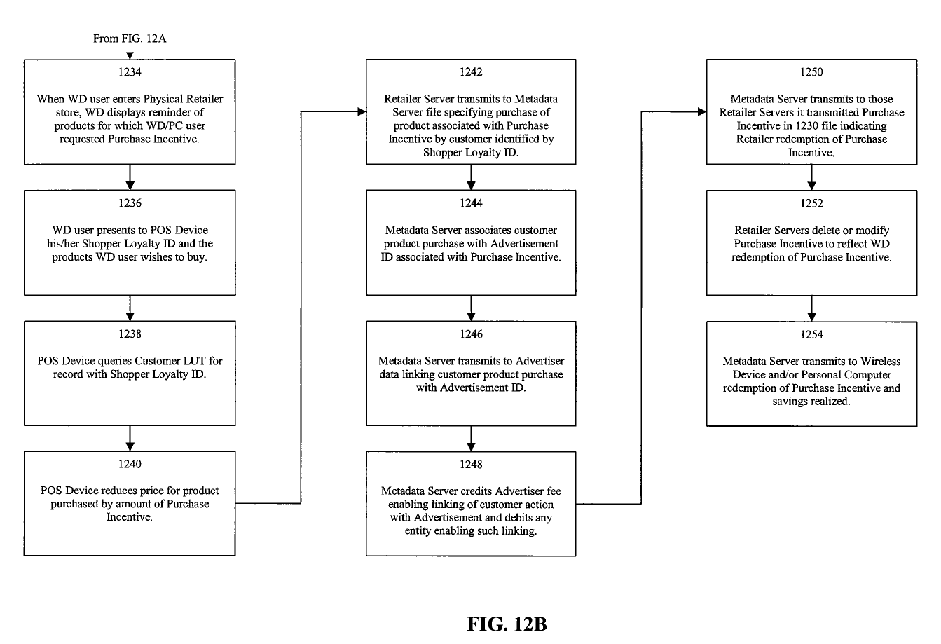

FIGS. 12A and 12B depict a flowchart of an exemplary Method 1200 for enabling the offer of a Purchase Incentive which can increase Incremental Purchases and profits. The flowchart refers to the systems and structures depicted in FIGS. 1-11. However, the flowchart is not limited to those embodiments. The flowchart can utilize a subset of the components, or additional, related, alternative, and/or equivalent components depicted in FIGS. 1-11. The flowchart can execute a subset of the steps, executing the steps in different order, and/or executing other or additional related or equivalent steps.

At 1210, a WD/NWD User can transmit to Metadata Server 0280 one or more Customer IDs, e.g., a Shopper Loyalty ID. In one embodiment, a WD/NWD User can input into a Wireless Device 0210 one or more or preferably, all, of the Shopper Loyalty IDs which WD/NWD User has been issued. Wireless Device 0210 can transmit to Metadata Server 0280 the Shopper Loyalty IDs. While the present method utilizes the example of Shopper Loyalty IDs, the disclosed systems and methods can support the input, transmission, processing, storage, and/or reception of any type of Customer ID.

At 1212, Metadata Server 0280 can store the Shopper Loyalty IDs in Customer Product Purchase Database 0510.

At 1214, Metadata Server 0280 can transmit a request for Product Purchase Data from one or more Data Processing Systems, including, but not limited to, the following. First, Metadata Server 0280 can request Product Purchase Data 0730 from the Retailer Server 0272 associated with a Shopper Loyalty ID stored in Customer Product Purchase Database 0510. For example, a WD/NWD User transmission of a Shopper Loyalty ID and the associated Retailer, e.g., the image of the Retailer typically displayed on the other side of a Shopper Loyalty card can enable the identification of the Retailer. Any method can be utilized to identify the IP address of Retailer Server 0272 associated with the Shopper Loyalty ID. In the example depicted in FIG. 7, Metadata Server 0280 can transmit a request for Product Purchase Data 0730 from each of the Retailer Servers 0710, 0712, 0714, and/or 0716. Second, Metadata Server 0280 can request Product Purchase Data 0740 from the Payment Processor 0720 associated with a Payment Method ID stored in Customer Product Purchase Database 0510. Third, Metadata Server 0280 can request Product Purchase Data 0750 from the Wireless Device 0210 and/or the Non-Wireless Device 0410 associated with the Shopper Loyalty ID stored in Customer Product Purchase Database 0510. Fourth, Metadata Server 0280 can request Product Purchase Data 0760 from Advertiser 0220 and/or Media Buyer 0222 associated with the Shopper Loyalty ID or any other Customer ID stored in Customer Product Purchase Database 0510.

Any Data Processing System can request Product Purchase Data at a variety of times, including, but not limited to, the following.

First, at 1214A, Metadata Server 0280 can transmit a Product Purchase Data request at any time between the time a WD/NWD User transmits a Customer ID, T_{USER-ID-TX}, and the time an Advertiser 0220 and/or Media Buyer 0222 transmits an Advertisement promoting a product, T_{ADV}. Because the identity of the product promoted by an Advertisement is unknown in the first example, Metadata Server 0280 should request Product Purchase Data for any purchased product associated with the Customer ID.

Second, at 1214B, Metadata Server 0280 can transmit a Product Purchase Data request at any time between T_{ADV} and the time a WD/NWD User initiates an User Initiating Input (UII), T_{UII}, or transmits an User Request, T_{UR}. Because Metadata Server 0280 transmits the Product Purchase Data request after T_{ADV} in the second example, Metadata Server 0280 can limit the products for which it requests Product Purchase Data to the product promoted and/or any related products associated with the Customer ID. For example, if an Advertiser 0220 transmits an Advertisement promoting a product, Product A, then a Data Processing System can assume that the WD/NWD Users can transmit User Requests for either Product A or any related products. Limiting the Product Purchase Data request to data for Product A or any related products can utilize less network capacity and storage capacity to exchange and store Product Purchase Data than the first example. Any method can be used to select products related to Product A.

Third, at 1214C, Metadata Server 0280 can transmit a Product Purchase Data request at any time after T_{UII} or T_{UR}. Because Metadata Server 0280 transmits the Product Purchase Data request after T_{UII} or T_{UR} in the third example, Metadata Server 0280 can limit the products for which it requests Product Purchase Data to the product requested associated with the Customer ID. Limiting the Product Purchase Data request to just Product A can utilize less network capacity and storage capacity than the second or first examples. However, requesting Product Purchase Data after T_{UII} or or T_{UR} can reduce the amount of time in which to retrieve and process Product Purchase Data given an objective of minimizing the response time T_{R}, i.e., the length of time between: (a) the time Wireless Device 0210 or Non-Wireless Device 0410 transmits an User Request; and (b) the time Wireless Device 0210 or Non-Wireless Device 0410 receives data responding to the User Request, e.g., displaying information about the product of interest, displaying information enabling Wireless Device 0210 user to purchase the product, or confirming the receipt of an electronic coupon. If a WD/NWD User transmits to Metadata Server 0280 a relatively small number of Customer IDs, then the small number of Retailer Servers 0272 from which Metadata Server 0280 needs to retrieve Product Purchase Data and the ability of Metadata Server 0280 to exchange a Product Purchase Data request and Product Purchase Data over a fast wide area network, e.g., the Internet, can reduce significantly the amount of time required to collect the Product Purchase Data from the relatively small number of Retailer Servers 0272. A variety of methods can reduce T_{R} by prefetching and storing in cache Product Purchase Data for those products for which any disclosed system or method can predict if a WD/NWD will probably transmit an User Request.

If many WD/NWD Users request Product Purchase Data, their requests can utilize a significant amount of network capacity and storage capacity. The larger the number of WD/NWD Users who can potentially transmit an User Request, the greater the savings in network capacity and/or storage capacity can be realized from executing 1214B or 1214C. For example, unlike the second example where Metadata Server 0280 can request Product Purchase Data for potentially all WD/NWD Users, Metadata Server 0280 in the third example can request Product Purchase Data for just one WD/NWD User.

At 1216, one or more Retailer Servers 0272 can transmit to Metadata Server 0280 the Product Purchase Data associated with products depending on the example in 1214. At 1214A, one or more Retailer Servers 0272 can transmit to Metadata Server 0280 the Product Purchase Data for any purchased product associated with the Customer ID. At 1214B, one or more Retailer Servers 0272 can transmit to Metadata Server 0280 the Product Purchase Data for the product promoted in an Advertisement and any related products associated with the Customer ID. At 1214C, one or more Retailer Servers 0272 can transmit to Metadata Server 0280 the Product Purchase Data for the product promoted in an Advertisement associated with the Customer ID. Metadata Server 0280 can store any data received from one or more Retailer Servers 0272 in Customer Product Purchase Database 0510.

At 1218, one or more Payment Processor 0720 can transmit to Metadata Server 0280 the Product Purchase Data associated with products depending on the example in 1214. The present method can repeat 1216 for Wireless Device 0120, Non-Wireless Device 0410, Advertiser 0220, and/or any other Data Processing System which can transmit Product Purchase Data associated with the Customer ID. Metadata Server 0280 can store any data received from one or more Payment Processors 0720 in Customer Product Purchase Database 0510.

At 1220, Advertiser 0220 and/or Media Buyer 0222 can transmit to Metadata Server 0280 a variety of data, which can include, but are not limited to: Product Purchase Incentive 0760; Ad Metadata File 0762; and/or Purchase Incentive Parameters 0610. Metadata Server 0280 can store any data received from one or more Advertisers 0220 and/or Media Buyers 0222 in Customer Product Purchase Database 0510.

At 1222, a Media Operator can transmit the Advertisement promoting a product of interest to a WD/NWD User.

At 1224, a Wireless Device 0210 user can transmit to Metadata Server 0280 or a Non-Wireless Device 0410 user can transmit to Metadata Server 0280 and/or Advertiser 0220 an User Request for a Purchase Incentive. For example, the WD/NWD User can transmit an User Request, “Save [Brand A] [Product B].” Any method can enable a WD/NWD User to transmit an User Request for a Purchase Incentive.

After receiving the User Request for a Purchase Incentive, Metadata Server 0280 can utilize any method to perform a variety of functions, including, but not limited to: processing the User Request; identifying the most likely Media Operator_{CAUSE}; identifying the most likely Advertisement_{CAUSE}; and/or looking up the Purchase Incentive associated with Advertisement_{CAUSE}.

Metadata Server 0280 can utilize any method to collect data identifying purchases of a product by a customer, retrieve Purchase Incentive Parameters 0610, and/or generate a desired Purchase Incentive. Any Data Processing System can vary the price discount, unit volume requirements, expiration date, and/or other parameters to provide the customer an incentive to purchase the number of units at a price which can increase Incremental Purchases, increase profits of the Advertiser 0220, increase profits of the Retailer, and/or meet any other objective of the Advertiser 0220 and/or Retailer.

For example, any Data Processing System can generate different desired Purchase Incentives for a Customer: New to Product Category 0930, a Customer: Loyal to Competitor Product 0932, and/or a Customer: Loyal to Vendor Product 0934.

At 1226, Metadata Server 0280 can transmit to Wireless Device 0210 and/or Non-Wireless Device 0410 a Purchase Incentive or data indicating that WD/NWD User will qualify for a Purchase Incentive on his/her next purchase of the product promoted in the Purchase Incentive at a Retailer. In one embodiment, Metadata Server 0280 can transmit to Wireless Device 0210 a Purchase Incentive which Wireless Device 0210 user can transmit to or display at a POS Device 0270 utilizing any method. In another embodiment, Metadata Server 0280 can transmit to Wireless Device 0210 and/or Non-Wireless Device 0410 data indicating that WD/NWD User will qualify for a Purchase Incentive on his/her next purchase of the product promoted in the Purchase Incentive at a Retailer. Because a Purchase Incentive can be redeemed without requiring the WD/NWD User to present to a POS Device 0270 a Purchase Incentive, Metadata Server 0280 can transmit to Wireless Device 0210 and/or Non-Wireless Device 0410 data just informing the WD/NWD User of the availability of the Purchase Incentive, the amount of the Purchase Incentive, instructions on how to redeem the Purchase Incentive, and/or any other information related to the Purchase Incentive.

At 1228, Metadata Server 0280 can identify the Retailer Server 0272 operated by the Retailer issuing the Shopper Loyalty ID to the WD/NWD User.

At 1230, Metadata Server 0280 can transmit to one or more Retailer Servers 0272 a file including data, which can include, but are not limited to: Shopper Loyalty ID or any other type of Customer ID; and/or a Desired Purchase Incentive File 0732.

At 1232, each Retailer Server 0272 can receive the file, read the data in the file, and/or write the Purchase Incentive to the relevant field in the record in a Customer Database identified by the Customer ID. Any method can apply the values of a Purchase Incentive to any purchase of the product specified in the Purchase Incentive by the customer identified by the Customer ID.

At 1234, when Wireless Device 0210 user enters a store of a Physical Retailer, Wireless Device 0210 can display a reminder of one or more products for which Wireless Device 0210 user and/or Non-Wireless Device 0410 user transmitted User Requests, in general, and/or requested a Purchase Incentive, in particular (“Purchase Incentive Product Reminder”). Purchase Incentive Product Reminder can be a computer program product receiving, processing, storing, and/or transmitting data about one or more Purchase Incentives. Any Data Processing System can generate and/or store the Purchase Incentive Product Reminder, including, but not limited to: Wireless Device 0210; Non-Wireless Device 0410; and/or Metadata Server 0280. The Data Processing System can identify any product listed in the Purchase Incentive Product Reminder by reading the Product ID associated with the product. However, to make it easier for a WD/NWD User to identify the products listed in the Purchase Incentive Product Reminder, the list can identify the products by the brand name and/or product name utilized by Advertiser 0220, which can be read from Ad Metadata File 0762.

Wireless Device 0210 can display on Display 0354 or transmit through any other I/O Device of Wireless Device 0210, e.g., by transmitting audio signals through a Wireless Device 0210 speaker, a Purchase Incentive Product Reminder through a variety of means, including, but not limited to, the following. First, a Wireless Device 0210 user can retrieve a list of products for which he/she requested a Purchase Incentive. In response to an event, e.g., an User Initiating Input, Program: WD 0338 can show on Display 0354 a menu of applications or data, one of which is a list of products for which he/she requested a Purchase Incentive. Second, Wireless Device 0210 can display a Purchase Incentive Product Reminder upon the occurrence of any event specifying that Wireless Device 0210 is in the vicinity of a Physical Retailer.

A variety of methods can enable the automatic display of a Purchase Incentive Product Reminder when Wireless Device 0210 moves within the vicinity of a Physical Retailer. First, a Physical Retailer can place a Wireless Device capable of broadcasting a signal utilizing any wireless protocol, e.g., Bluetooth, which can be received by one or more Wireless Devices 0210. The signal can carry data which can cause an event handler in a computer program product located in Wireless Device 0210, e.g., Program: WD 0338, to process the event by calling a program which can display the Purchase Incentive Product Reminder.

In another embodiment, Metadata Server 0280 can transmit to Wireless Device 0210 the Purchase Incentive Product Reminder listing one or more products for which Non-Wireless Device 0410 user transmitted User Requests, in general, and/or requested a Purchase Incentive, in particular. At setup or any later time, Non-Wireless Device 0410 can transmit to Metadata Server 0280 any address identifying the Wireless Device 0210 utilized by the Non-Wireless Device 0410 user. The Wireless Device 0210 address can include, but is not limited to: the phone number of the Wireless Device 0210; the IP address of the Wireless Device 0210; the electronic identification number (EIN) of the Wireless Device 0120; and/or the SIM card number associated with the Wireless Device 0210 user.

At 1236, after selecting one or more products listed in Purchase Incentive Product Reminder, Wireless Device 0210 user can present to POS Device 0270 at least: (a) the Shopper Loyalty ID; and (b) one or more products Wireless Device 0210 user wants to buy which are also products included in the Purchase Incentive Product Reminder. Wireless Device 0210 user can present to POS Device 0270 the Shopper Loyalty ID through a variety of methods, including, but not limited to: scanning the Shopper Loyalty ID card, which can be read by one or more I/O Devices integrated with or connected to POS Device 0270; scanning an image, e.g., a barcode, of the Shopper Loyalty ID displayed on Display 0354 of Wireless Device 0210; and/or communicating to a person operating the POS Device 0270 the Shopper Loyalty ID and/or any other data identifying Wireless Device 0210 user as a member of the Shopper Loyalty program.

At 1238, POS Device 0270 can query the Customer Database for the record identified by the Shopper Loyalty ID.

At 1240, POS Device 0270 can utilize any method to apply the values of a Purchase Incentive to any purchase of the product specified in the Purchase Incentive by the customer identified by the Customer ID. POS Device 0270 can apply the value of the Purchase Incentive only if the customer purchase meets any requirements specified in the Purchase Incentive.

At 1242, if the customer purchases one or more products whose Product ID equaled any of the Product IDs associated with a Purchase Incentive, Retailer Server 0272 can transmit to Metadata Server 0280 Purchase Incentive Redemption Data 0734.

At 1244, Metadata Server 0280 can parse Purchase Incentive Redemption Data 0734 received from one or more Retailer Servers 0272 and read one or more Product IDs listed in Purchase Incentive Redemption Data 0734. Metadata Server 0280 can query any database storing one or more Purchase Incentives requested by a WD/NWD User, which can include a variety of data, including, but not limited to: the Purchase Incentive requested; the Product ID of the product promoted in the Purchase Incentive; and/or the Advertisement identified by, e.g., the Advertisement ID, promoting the Purchase Incentive and/or the product promoted in the Purchase Incentive. Any method disclosed in U.S. patent application Ser. No. 12/107,649 can identify the most likely Advertisement leading a WD/NWD User to transmit an User Request, in general, or a Purchase Incentive, in particular. Metadata Server 0280 can generate a file associating a Product ID listed in Purchase Incentive Redemption Data 0734 and the Advertisement ID promoting the product identified by the Product ID (“Advertisement/Product Purchase Data”).

At 1246, Metadata Server 0280 can transmit the Advertisement/Product Purchase Data to the Advertiser 0220 and/or Media Buyer 0220 which transmitted the Advertisement promoting the Purchase Incentive and/or product purchased by WD/NWD User.

At 1248, Metadata Server 0280 can credit Advertiser 0220 and/or Media Buyer 0222 a fee enabling Advertiser 0220 to meet any objective, e.g., receiving Advertisement/Product Purchase Data and debit any entity enabling Advertiser 0220 to meet any objective.

At 1250, Metadata Server 0280 can transmit to one or more Retailer Servers 0272 which it had transmitted a Desired Purchase Incentive 0732 a file indicating that the WD/NWD User identified by Customer ID had redeemed the Desired Purchase Incentive 0732. The benefits of transmitting the data to other Retailer Servers 0272 can include, but are not limited to, enabling Advertiser 0220 and/or Media Buyer 0222 providing the Desired Purchase Incentive 0732 to encourage WD/NWD User to make Incremental Purchases, but not those purchases of products which may not be profitable to Advertiser 0220.

At 1252, one or more Retailer Servers 0272 receiving the file indicating WD/NWD User had redeemed the Desired Purchase Incentive 0732 can delete or modify the Purchase Incentive stored in their Customer Databases.

At 1254, Metadata Server 0280 can transmit to Wireless Device 0210 and/or Non-Wireless Device 0410 data, which can include, but are not limited to: data indicating that WD/NWD User had redeemed the Purchase Incentive; and/or data specifying the savings realized.

By transmitting a Purchase Incentive to Retailer Server 0272 which can apply the value of the Purchase Incentive to any transaction executed by a customer at POS 0270, Metadata Server 0280 can enable a customer to benefit from a Purchase Incentive at a physical retailer.

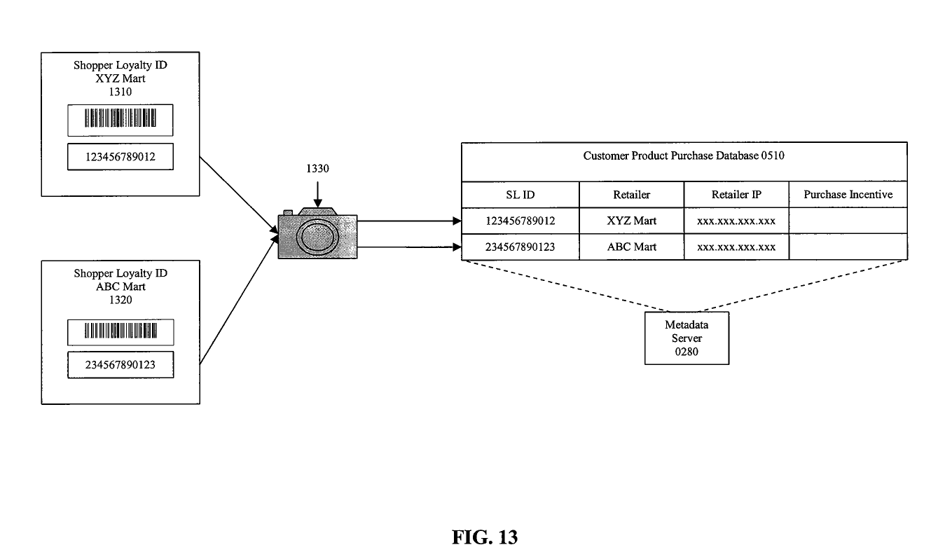

FIGS. 13-18 describe in more detail three primary elements of exemplary Method 1200: (a) the collection of the Customer ID, which enables the identification of the customer buying products at a Retailer; (b) the association of an Advertisement viewed by a WD/NWD User with the Customer ID; and (c) the processing of a Purchase Incentive enabling the Purchase Incentive redemption without requiring the WD/NWD User to present the Purchase Incentive.

FIG. 13 depicts a block diagram of an exemplary system enabling the collection of one or more Customer IDs from a WD/NWD User. The system can utilize a subset of the following components, or additional, related, alternative, and/or equivalent components. The system can include, but is not limited to, the following components not disclosed earlier herein.

Shopper Loyalty ID 1310 is a Shopper Loyalty ID issued by an exemplary Retailer, XYZ Mart. Shopper Loyalty ID 1310 can be represented in any format which can be read by one or more I/O Devices of Wireless Device 0210 and/or Non-Wireless Device 0410. In one embodiment, Camera 1330 can record an image of Shopper Loyalty ID 1310 for reception, processing, storage, and/or transmission by Wireless Device 0210 and/or Non-Wireless Device 0410. Camera 1330 can be integrated with or connected to Wireless Device 0210 and/or Non-Wireless Device 0410.

Shopper Loyalty ID 1320 is a Shopper Loyalty ID issued by another exemplary Retailer, ABC Mart, with the same functionality as Shopper Loyalty ID 1310.

Camera 1330 can be a separate camera or integrated with or connected to Wireless Device 0210 and/or Non-Wireless Device 0410.

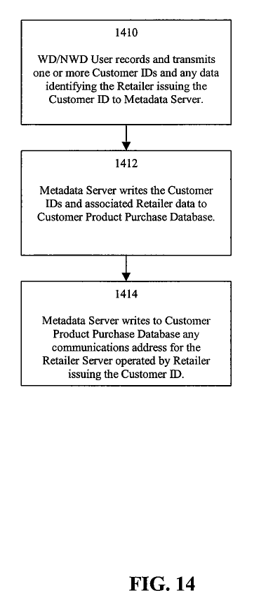

FIG. 14 depicts a flowchart of an exemplary Method 1400 for enabling the collection of one or more Customer IDs. The flowchart refers to the systems and structures depicted in FIG. 13. However, the flowchart is not limited to those embodiments. The flowchart can utilize a subset of the components, or additional, related, alternative, and/or equivalent components depicted in FIG. 13. The flowchart can execute a subset of the steps, executing the steps in different order, and/or executing other or additional related or equivalent steps.

At 1410, WD/NWD User can receive, record, store, and/or transmit any Customer ID utilizing any disclosed method. In one embodiment, a Wireless Device 0210 user can utilize Camera 1330, which can be independent of, connected to, or integrated with a Wireless Device 0210, to record an image of one or more Shopper Loyalty ID cards, e.g., Shopper Loyalty ID 1310 and Shopper Loyalty ID 1320. After receiving the data, Wireless Device 0210 can transmit the data to Metadata Server 0280 utilizing any protocol, including, but not limited to, short messaging service (SMS), multimedia messaging service (MMS), wireless application protocol (WAP), and/or HTTP. A variety of methods can transmit the data to Metadata Server 0280, including, but not limited to: (a) utilizing a computer program product located in Wireless Device 0210 to receive the image of a barcode printed on a Shopper Loyalty ID card, converting the barcode into an alphanumeric string, and/or transmitting the alphanumeric string utilizing any messaging protocol, e.g., SMS; and/or (b) transmitting the image of the Shopper Loyalty ID card utilizing any messaging protocol, e.g., MMS.

At 1412, after Metadata Server 0280 receives from a Wireless Device 0210 and/or Non-Wireless Device 0410 the data representing one or more Customer IDs and the associated Retailer, Metadata Server 0280 can write to one or more databases, e.g., Customer Product Purchase Database 0510, the Customer IDs and associated Retailer associated with one WD/NWD User. The database can create a new record for a WD/NWD User for which Metadata Server 0280 does not have any data or write to an existing record for a WD/NWD User for which Metadata Server 0280 has existing data. For example, a WD/NWD User can join a Shopper Loyalty program after transmitting one or more Shopper Loyalty IDs at setup. The WD/NWD User can transmit the new Shopper Loyalty ID to Metadata Server 0280, which can add the new Shopper Loyalty ID to the existing record storing Shopper Loyalty IDs for the WD/NWD User.

At 1414, Metadata Server 0280 can lookup an internal or external database including the communications address for each of the Retailers issuing a Customer ID. The communications address can include any address enabling Metadata Server 0280 to exchange any data with any Data Processing System operated by the Retailer, e.g., Retailer Server 0272. The communications address can include any address including, but not limited to: an address identifying a location or resource within an open network, e.g., the Internet; and/or an address identifying a location or resource within a proprietary network. After identifying the communications address enabling Metadata Server 0280 to exchange data with a Data Processing System operated by the Retailer, Metadata Server 0280 can write to the record for the WD/NWD User the communications address, e.g., the IP address of Retailer Server 0272.

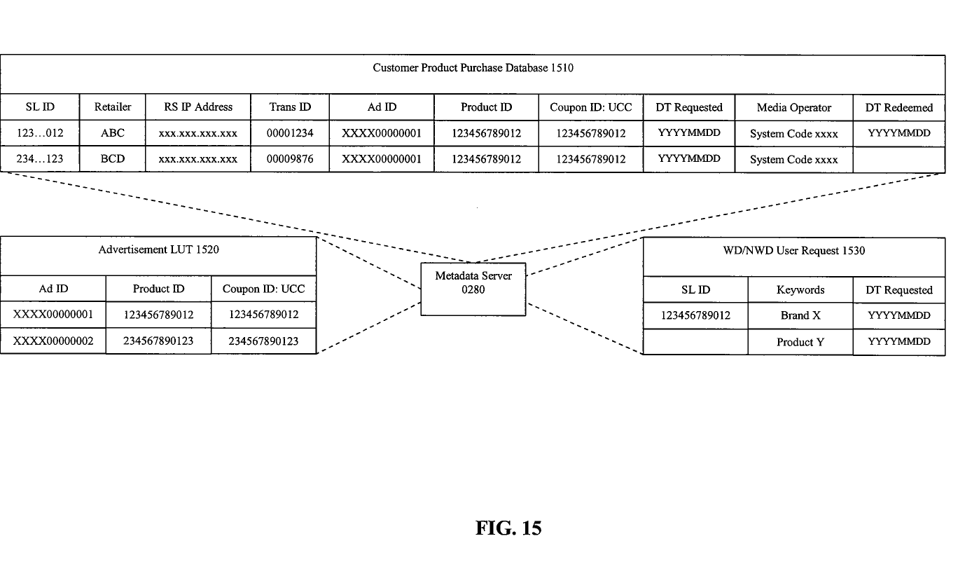

FIG. 15 depicts a block diagram of an exemplary system enabling the population of a data structure, e.g., Customer Product Purchase Database. The present system can utilize a subset of the following components, or additional, related, alternative, and/or equivalent components. The present system can include, but is not limited to, the following components not disclosed earlier herein.

Customer Product Purchase Database 1510 can be any data structure which can include any data included in Customer Product Purchase Database 0510 and additional data, including, but not limited to: (a) a primary key, e.g., a Customer ID where in one embodiment can be a Shopper Loyalty ID; (b) the Retailer issuing the Customer ID; (c) the communications address of one or more Retailer Servers 0272 operated by the Retailer issuing the Customer ID; (d) any data uniquely identifying one or more User Requests transmitted by the WD/NWD User, e.g., the value for the Retailer Transaction ID field; (e) any data uniquely identifying one or more Advertisements most likely stimulating any given User Request, e.g., Ad-ID; (f) any data uniquely identifying the product requested in User Request and/or promoted in Advertisement_{CAUSE}, e.g., the UPC; (g) any data uniquely identifying a Purchase Incentive offered by the Advertiser 0220 in Advertisement_{CAUSE}, e.g., the UCC; (h) the date/time Metadata Server receives the User Request and/or the date/time the WD/NWD User transmits the User Request; (i) any data uniquely identifying the Media Operator displaying Advertisement_{CAUSE}, e.g., the System Code identifying a Television Media Operator; and/or (j) the date/time WD/NWD User purchased the product promoted in Advertisement_{CAUSE}.

Customer Product Purchase Database 1510 can include one or more records, each of which can include one or more Customer IDs. For example, a WD/NWD User can shop regularly at a plurality of Retailers and be a member of each of the Retailer's Shopper Loyalty programs. Customer Product Purchase Database 1510 can include for each WD/NWD User any and all the Shopper Loyalty IDs utilized by the user.

Advertisement LUT 1520 can be any data structure which can include any data included in Operator/Advertisement/Programming LUT 1500 disclosed in U.S. patent application Ser. No. 12/107,649.

WD/NWD User Request 1530 can be any file which can include any data included in an User Request as discussed in U.S. patent application Ser. No. 12/107,649.

Any method can associate with each Retailer an unique identification code. For example, each Payment Processor 0720 typically assigns to each Retailer an unique identification code, e.g., a Merchant Identification (MID) code issued by existing Payment Processors.

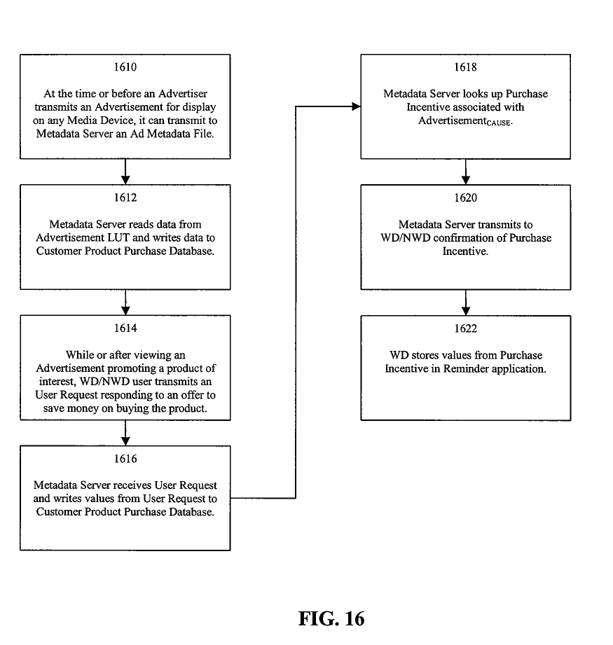

FIG. 16 depicts a flowchart of an exemplary Method 1600 for enabling the population of a data structure, e.g., Customer Product Purchase Database. The flowchart refers to the systems and structures depicted in FIG. 15. However, the flowchart is not limited to those embodiments. The flowchart can utilize a subset of the components, or additional, related, alternative, and/or equivalent components depicted in FIG. 15. The flowchart can execute a subset of the steps, executing the steps in different order, and/or executing other or additional related or equivalent steps.

At 1610, at the time or before an Advertiser 0220 or Media Buyer 0222 transmits an Advertisement for display on any Media Device, Advertiser 0220 and/or Media Buyer 0222 can transmit to Metadata Server 0280 an Ad Metadata File 0762. Metadata Server 0280 can read from Ad Metadata File 0762 one or more attributes and associated values and write the data to Advertisement LUT 1520.

At 1612, Metadata Server 0280 can read any data from Advertisement LUT 1520 and write the data to Customer Product Purchase Database 1510. In another embodiment, Metadata Server 0280 can read from one or more Ad Metadata Files 0762 any attributes and associated data and write the data directly to Customer Product Purchase Database 1510.

At 1614, while or after a WD/NWD User views on any Media Device an Advertisement promoting a product of interest, he/she can transmit an User Request 1530 responding to an Advertiser 0220 offer to save money on the purchase of the product of interest. The WD/NWD User can utilize any method disclosed in U.S. patent application Ser. No. 12/107,649 to generate and/or transmit an User Request 1530.

At 1616, Metadata Server 0280 can receive the User Request 1530 and write one or more values included in the User Request 1530 to Customer Product Purchase Database 1510.

At 1618, Metadata Server 0280 can lookup the Purchase Incentive associated with the Advertisement_{CAUSE} identified utilizing any method disclosed in U.S. patent application Ser. No. 12/107,649. In another embodiment, Metadata Server 0280 can lookup the Purchase Incentive associated with the product identified by the User Request 1530 but not associated with an Advertisement_{CAUSE} identified. U.S. patent application Ser. No. 12/107,649 discloses systems and methods enabling the looking up of metadata associated with an Advertisement even if the systems and methods do not identify the most likely Advertisement to stimulate an User Request. For example, if a WD/NWD User transmits an User Request including one or more Keywords/Keyphrases specifying a vendor, brand, and/or product and an Advertisement_{CAUSE} is not identified, then any Data Processing System, e.g., Metadata Server 0280, can lookup any metadata, e.g., a Purchase Incentive, associated with the vendor, brand, and/or product specified in the User Request.

At 1620, Metadata Server 0280 can transmit to Wireless Device 0210 and/or Non-Wireless Device 0410 the Purchase Incentive, a confirmation of the request for the Purchase Incentive, and/or any other data relating to the Purchase Incentive associated with the product specified in the User Request. In one embodiment, Metadata Server 0280 can transmit to Wireless Device 0210 an electronic coupon which the Wireless Device 0210 user can transmit to a POS Device 0270 utilizing one or more I/O Devices of Wireless Device 0210. For example, Metadata Server 0280 can transmit an electronic coupon in the form of a barcode which Display 0354 of Wireless Device 0210 can display and which a barcode reader attached to or integrated with POS Device 0270 can read. In another embodiment, Metadata Server 0280 can transmit to Wireless Device 0210 data specifying a variety of information about the Purchase Incentive requested by Wireless Device 0210, including, but not limited to: (a) data specifying that WD/NWD User can automatically receive the value of the Purchase Incentive in his/her next purchase of the product associated with the Purchase Incentive in a Physical Retailer; and/or (b) data including attributes and values identifying one or more Purchase Incentives requested which Wireless Device 0210 can write to a Purchase Incentive Product Reminder stored in Memory 0320.

At 1622, Wireless Device 0210 can write the attributes and/or values included in a Purchase Incentive to any computer program product, e.g., Purchase Incentive Product Reminder, which Wireless Device 0210 can display on Display 0354 when Wireless Device 0210 user enters a Physical Retailer. Wireless Device 0210 can call the Purchase Incentive Product Reminder automatically upon receiving any event trigger or Wireless Device 0210 user can call the Purchase Incentive Product Reminder.

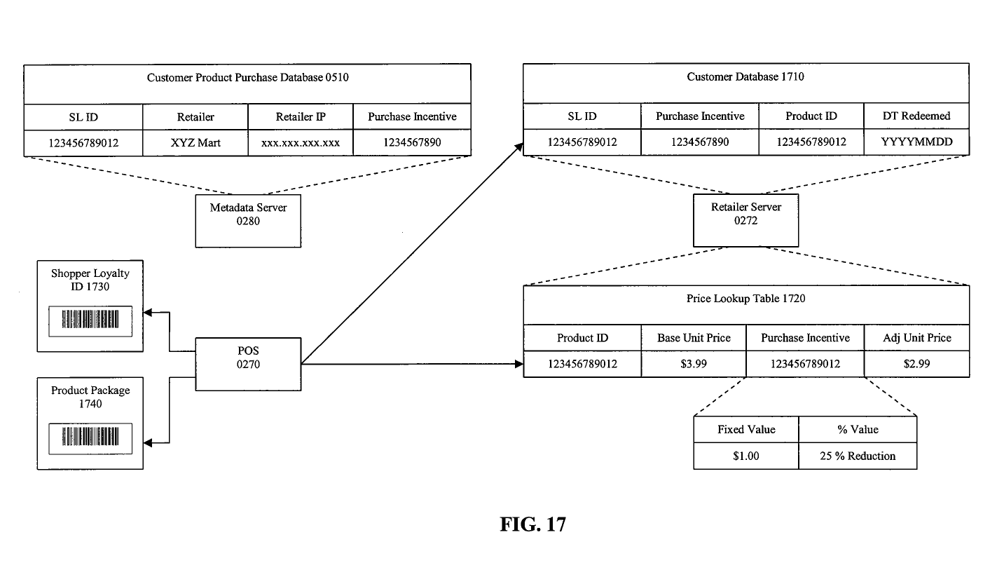

FIG. 17 depicts a block diagram of an exemplary system enabling the exchange of data among a variety of data structures, e.g., a Customer Product Purchase Database, a Customer Database, and/or a Price Lookup Table. The present system can utilize a subset of the following components, or additional, related, alternative, and/or equivalent components. The present system can include, but is not limited to, the following components not disclosed earlier herein.

Customer Database 1710 can be any data structure operated by a Retailer which can include any data related to a customer, including, but not limited to: (a) a primary key, e.g., a Customer ID where in one embodiment can be a Shopper Loyalty ID; (b) one or more Purchase Incentives received from Metadata Server 0280; (c) the Product ID of the product promoted by the Purchase Incentive; (d) and/or the date/time the customer purchased the product promoted by the Purchase Incentive after Retailer Server 0272 received the Purchase Incentive (“Qualifying Purchase Date/Time”).

Retailer Server 0272 can write to Customer Database 1710 the Qualifying Purchase Date/Time which meets one or more of the following criteria: (a) if the customer purchases the product identified by the Product ID included in the Purchase Incentive; (b) if the customer purchases the product identified by the Product ID after Retailer Server 0272 writes the Purchase Incentive to Customer Database 1710; and/or (c) if the customer purchases the product identified by the Product ID before the expiration date, if any, specified in the Purchase Incentive (collectively, “Qualifying Purchase”). The objective of including the second criterion in determining a Qualifying Purchase is to limit the applicability of the Purchase Incentive to those purchases of the product by a customer after the customer viewed an Advertisement promoting the product. Because the Customer Database 1710 would receive the Purchase Incentive only after the customer transmitted an User Request for the product promoted by the Purchase Incentive, including the purchase of the product promoted after Customer Database 1710 receives the Purchase Incentive assures the counting of only those purchases of products after the customer viewed an Advertisement promoting the product purchased.

Price Lookup Table 1720 can be any data structure operated by a Retailer for storing the price of any product offered for sale. In a typical transaction, a POS Device 0270 can query a Price Lookup Table 1720 to read the unit price for the product purchased. After reading the base unit price in the Price Lookup Table 1720, a Retailer Server 0272 typically queries a Customer Database 1710 to read any Purchase Incentives which are applicable to the purchase of the product by the customer. For example, if a customer is a member of the Retailer Shopper Loyalty program, he/she can qualify for any Purchase Incentives offered to the members, Retailer Server 0272 can read from Customer Database 1710 any Purchase Incentive, and Retailer Server 0272 can apply the incentive to adjust the base unit price in Price Lookup Table 1720. In another example, if a customer is a member of any group for which the Retailer has agreed to process any Purchase Incentive, he/she can qualify for any Purchase Incentive offered to members of the group, Retailer Server 0272 can read from Customer Database 1710 any Purchase Incentive, and Retailer Server 0272 can apply the incentive to adjust the base unit price in Price Lookup Table 1720. If Retailer Server 0272 writes to Customer Database 1710 any Purchase Incentive received from Metadata Server 0280, Retailer Server 0272 can read from Customer Database 1710 the Purchase Incentive, and Retailer Server 0272 can apply the incentive to adjust the base unit price in Price Lookup Table 1720.

Product ID 1740 can be any Product ID identifying the product purchased by the customer, e.g., a barcode identifying the product which can be read by one or more I/O Devices integrated with or connected to POS Device 0270.

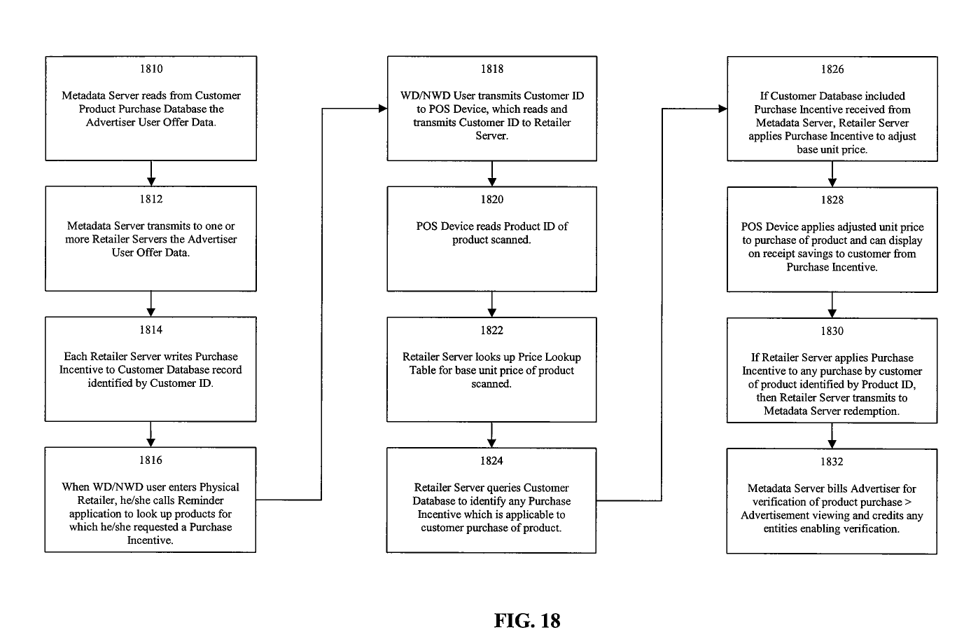

FIG. 18 depicts a flowchart of an exemplary Method 1800 for enabling the exchange of data among a variety of data structures, e.g., a Customer Product Purchase Database, a Customer Database, and/or a Price Lookup Table. The flowchart refers to the systems and structures depicted in FIG. 17. However, the flowchart is not limited to those embodiments. The flowchart can utilize a subset of the components, or additional, related, alternative, and/or equivalent components depicted in FIG. 17. The flowchart can execute a subset of the steps, executing the steps in different order, and/or executing other or additional related or equivalent steps.

At 1810, Metadata Server 0280 can read from Customer Product Purchase Database 0510 one or more data enabling one or more Retailers to identify, process, transmit and/or perform any other function related to a Purchase Incentive associated with a Customer ID. In one embodiment, Metadata Server 0280 can read from Customer Product Purchase Database 0510 the following data from the record of a WD/NWD User who transmitted an User Request, including, but not limited to: one or more Customer IDs, e.g., a Shopper Loyalty ID; the address of each Retailer issuing the respective Shopper Loyalty ID, e.g., the IP address of the Retailer; and the Purchase Incentive offered by the Advertiser 0220 and/or Media Buyer 0222 in the Advertisement stimulating the User Request (“Advertiser User Offer Data”).

At 1812, Metadata Server 0280 can transmit to Retailer Server 0272 the Advertiser User Offer Data. Metadata Server 0280 can transmit the data through any type of network, e.g., the Internet.

At 1814, Retailer Server 0272 can receive the Advertiser User Offer Data and write the data to the record in Customer Database 1710 identified by the Customer ID included in Advertiser User Offer Data. For example, Customer Product Purchase Data 0510 can include a Shopper Loyalty ID 123456789012 issued by Retailer XYZ Mart. Because the Customer Product Purchase Database 0510 can include only those Shopper Loyalty IDs inputted by the WD/NWD User, a variety of methods can ensure that the inputted Shopper Loyalty IDs exactly match the Shopper Loyalty IDs in Customer Database 1710.

There can be a variety of reasons why the Shopper Loyalty IDs in Customer Product Purchase Database 0510 may not match the Shopper Loyalty ID in Customer Database 1710. First, the WD/NWD User can input only the Shopper Loyalty ID and not input any data identifying the Retailer issuing the Shopper Loyalty ID. At setup, a Data Processing System can prompt the WD/NWD User to input the Retailer associated with a Shopper Loyalty ID. Second, the WD/NWD User can transmit an image of a Shopper Loyalty ID and transmit an image of a Retailer of a different Shopper Loyalty ID. A variety of methods can ensure the association of a Shopper Loyalty ID with the Retailer which issued the Shopper Loyalty ID, including, but not limited to, the following method: (a) after receiving the Shopper Loyalty ID and the Retailer ID Data, Metadata Server 0280 can transmit to the Retailer which the WD/NWD User indicates is associated with the Customer ID a query requesting the Retailer to confirm the association; (b) the Retailer can query its Customer Database to determine if the Customer ID is associated with a record whose other data matches or indicates that the WD/NWD User is a member of its Shopper Loyalty program; and/or (c) if the Retailer determines that the WD/NWD User is probably not a member of its Shopper Loyalty program, Metadata Server 0280 can transmit a message to WD/NWD User asking him/her to confirm the association of the Shopper Loyalty ID with the Retailer ID Data.

At 1816, the present method can repeat 1234.

At 1818, WD/NWD User can transmit to a POS Device 0270 a Customer ID, e.g., a Shopper Loyalty ID issued by the Retailer from which WD/NWD User is purchasing one or more products. POS Device 0270 can read and transmit the Customer ID to Retailer Server 0272.

At 1820, POS Device 0270 can read the Product ID of one or more products through one or more I/O Devices integrated with or connected to POS Device 0270.

At 1822, Retailer Server 0272 can lookup a Price Lookup Table 1720 and read the base unit price of each product whose Product ID is read by POS Device 0270.

At 1824, Retailer Server 0272 can query Customer Database 1710 to identify any Purchase Incentive applicable to the customer purchase of the product identified by Product ID. In a typical Retailer, Retailer Server 0272 can read from Customer Database 1710 or any other data structure any Purchase Incentive which it can apply to the purchase of a product. The Purchase Incentive can be offered by the Retailer or any entity external to the Retailer. In one embodiment, Retailer Server 0272 can identify the Purchase Incentive received from Metadata Server 0280.

At 1826, Retailer Server 0272 can apply any Purchase Incentive received from Metadata Server 0280 to adjust the base unit price of the product.

At 1828, POS Device 0270 can apply the adjusted unit price to the purchase of the product and/or display on any type of receipt, including, but not limited to, a paper-based receipt, and/or an electronic receipt, the savings accruing to the customer from application of the Purchase Incentive.

At 1830, Retailer Server 0272 can transmit to Metadata Server 0280 data specifying any application of the Purchase Incentive received from Metadata Server 0280 to the purchase of the product identified by Product ID in the Purchase Incentive.

At 1832, Metadata Server 0280 can: (a) bill Advertiser 0220 and/or Media Buyer 0222 for verifying the purchase of the product promoted in an Advertisement viewed by WD/NWD User; and (b) credit any entity enabling the verification.

If Advertiser 0220 and/or Media Buyer 0222 want to limit the redemption of the Purchase Incentive to the number of units specified in the Purchase Incentive, it can implement the limitation through a variety of methods, including, but not limited to, the following. After Metadata Server 0280 receives from any Retailer Server 0272 to which it originally transmitted a Purchase Incentive any data verifying that the WD/NWD User purchased the product promoted in the Purchase Incentive, Metadata Server 0280 can transmit to any or all Retailer Servers 0272 to which it originally transmitted a Purchase Incentive data specifying that the Retailer Server 0272 should delete the Purchase Incentive from its Customer Database 1710 and/or modify the Purchase Incentive to ensure that Retailer Server 0272 does not apply the Purchase Incentive to any purchase of the product promoted in the Purchase Incentive.

### 6.2 Credit/Debit Card Method

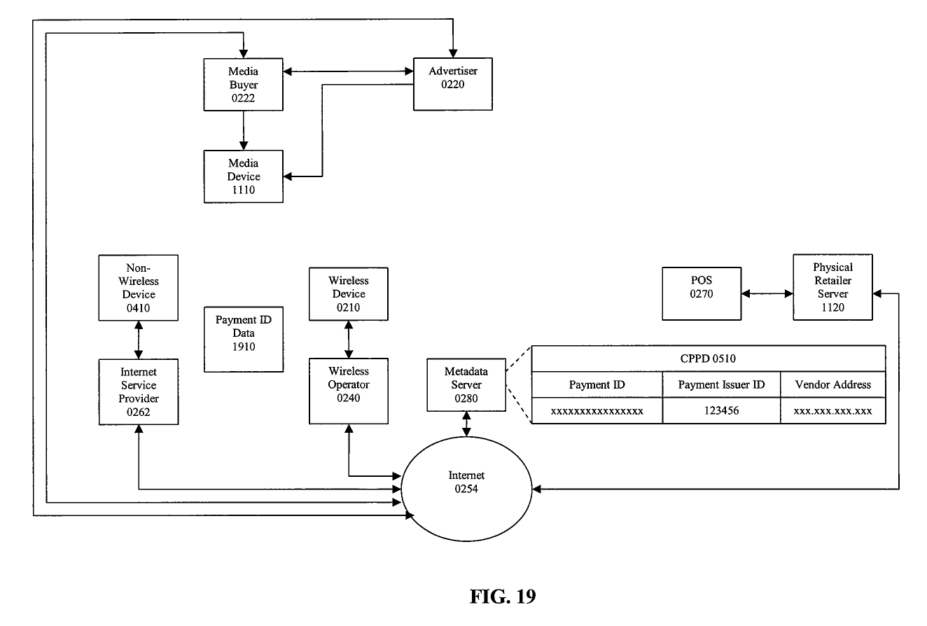

FIG. 19 depicts a block diagram of an exemplary system enabling the collection of one or more Customer IDs from a WD/NWD User where the Customer ID is a Payment ID. The present system can utilize a subset of the following components, or additional, related, alternative, and/or equivalent components. The present system can include, but is not limited to, the following components not disclosed earlier herein.

Payment ID Data 1910 can be any data specifying a Payment ID issued by a Payment Processor 0720. Wireless Device 0210 and/or Non-Wireless Device 0410 can transmit one or more Payment IDs to Metadata Server 0280.

Customer Product Purchase Database 0510 described in FIG. 5 can include additional data including, but not limited to: (a) any Payment ID issued by a Payment Processor 0720; (b) the Payment Issuer ID, i.e., any code identifying the Payment Processor 0720 issuing the Payment ID; and/or (c) the communications address of any Data Processing System operated by the Payment Processor 0720 which can exchange data with other Data Processing Systems, including, but not limited to, Metadata Server 0280, and/or Retailer Server 0272. Any Data Processing System can utilize any code identifying a Payment Processor 0720, including, but not limited to: a standard code utilized in the payment processing industry, e.g., a Bank ID; and/or a proprietary code utilized by a Payment Processor 0720.

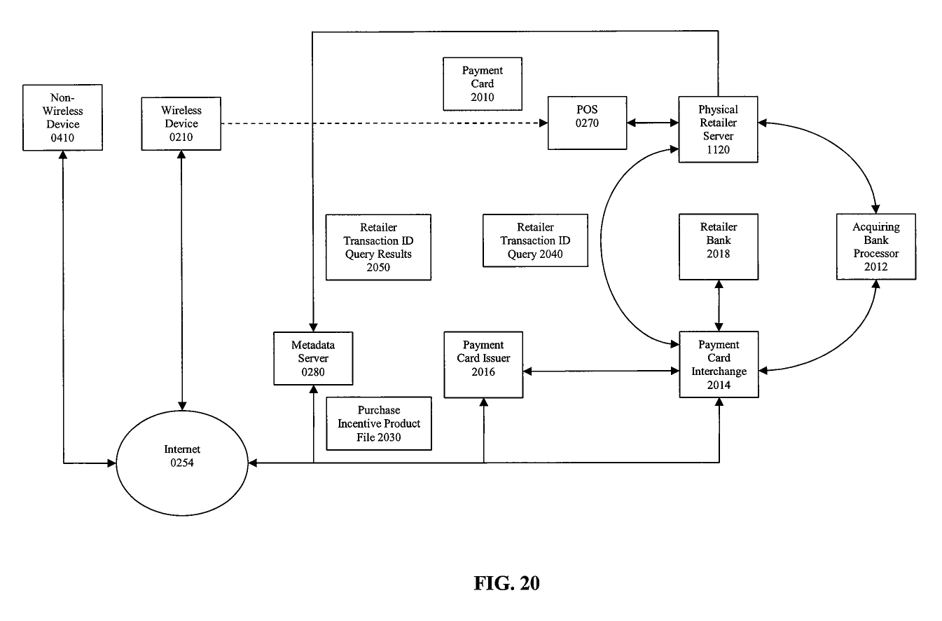

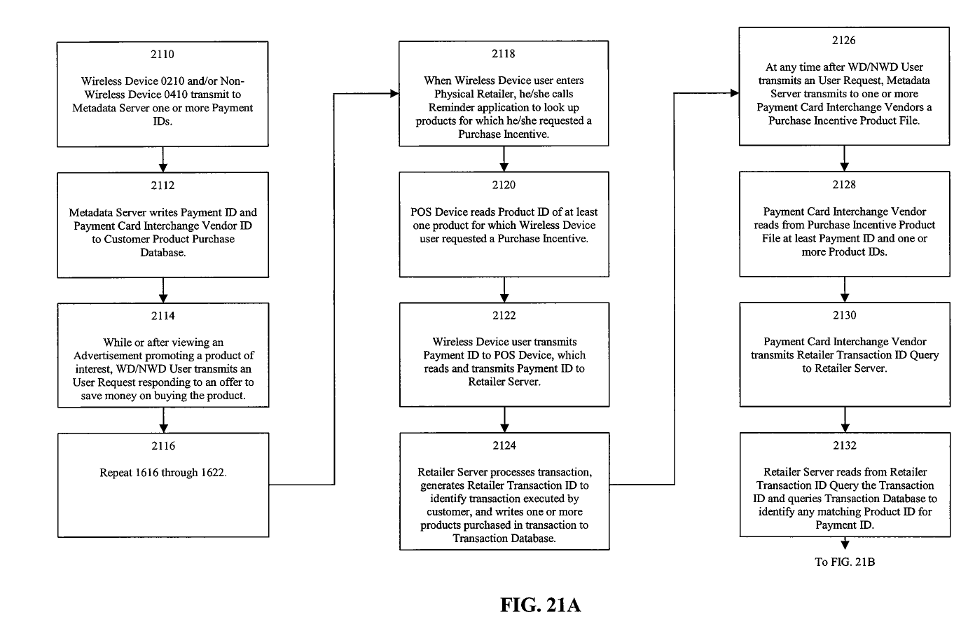

FIG. 20 depicts a block diagram of an exemplary system enabling the exchange of data among a variety of Data Processing Systems to verify if a WD/NWD User purchased a product utilizing an electronic payment method. While the present system depicts an exemplary system illustrating the exchange of data for purchasing one or more products at a Physical Retailer, it is not limited to that embodiment. An exemplary system can enable the exchange of data among a variety of Data Processing Systems to verify if a WD/NWD User purchased a product at any type of Retailer utilizing an electronic payment method. While the present system depicts an exemplary system illustrating the exchange of data processing the purchase of a product utilizing a typical credit card, it is not limited to that embodiment. An exemplary system can exchange data processing the purchase of a product utilizing any kind of payment method, including, but not limited to: a debit card, a charge card, and/or a check, either in paper or electronic form. The present system can utilize a subset of the following components, or additional, related, alternative, and/or equivalent components. The present system can include, but is not limited to, the following components not disclosed earlier herein.

Payment Card 2010 can be any data specifying a Payment ID and/or other data enabling the holder of Payment Card 2010 to implement an electronic payment. A WD/NWD User can present and/or input the Payment ID to POS Device 0270 utilizing any method, including, but not limited to: (a) swiping Payment Card 2010 utilizing any apparatus capable of reading Payment ID from Payment Card 2010 and transmitting Payment ID to any Data Processing System capable of processing an electronic payment; and/or (b) inputting Payment ID utilizing any other I/O Device integrated with or connected to POS Device 0270, e.g., a keypad or keyboard.

Acquiring Bank Processor 2012 can be any Data Processing System capable of processing any electronic payment utilizing any method. In a typical electronic payment processing, an Acquiring Bank Processor 2012 can process credit/debit card transactions for a merchant.

Payment Card Interchange 2014 can be any Data Processing System capable of processing, clearing, and settling an electronic transaction utilizing any method. In a typical electronic payment processing, a Payment Card Interchange 2014 can assess, collect, and/or distribute fees among the parties enabling the electronic transaction.

Payment Card Issuer 2016 can be any Data Processing System capable of verifying the availability of funds and/or credit in the account of the customer utilizing the Payment Card 2010 to purchase the product.

Retailer Bank 2018 can be any Data Processing System capable of receiving the proceeds of the electronic payment.

Purchase Incentive Product File 2030 can include any data specifying one or more Product IDs for which the WD/NWD User identified by the Customer ID requested a Purchase Incentive. For example, if the WD/NWD User viewed an Advertisement displayed on any Media Device requested a Purchase Incentive for the product promoted in the Advertisement, Metadata Server 0280 can generate a file including one or more Purchase Incentives requested by the WD/NWD User and the Product ID associated with each Purchase Incentive, i.e., the Product ID identifying the product promoted by the Purchase Incentive. Metadata Server 0280 can transmit Purchase Incentive Product File 2030 to any Data Processing System capable of facilitating the identification of any Product ID purchased by WD/NWD User. These Data Processing Systems can include, but are not limited to: Acquiring Bank Processor 2012; Payment Card Interchange 2014; Payment Card Issuer 2016; Retailer Bank 2018; and/or any other Data Processing System involved in the processing of an electronic transaction. In the present embodiment, Metadata Server 0280 can transmit Purchase Incentive Product File 2030 to one or more Payment Card Interchanges 2014. The benefit of transmitting the Purchase Incentive Product File 2030 to Payment Card Interchanges 2014 is the relatively small number of Payment Card Interchanges 2014.

Retailer Transaction ID Query 2040 can include any data enabling a Retailer Server 0272 to identify one or more Product IDs identifying the products purchased in a transaction identified by Retailer Transaction ID. In a typical transaction, a Retailer Server 0272 can assign a Retailer Transaction ID to the transaction implementing the purchase of one or more products. Retailer Server 0272 can include in the record identified by Retailer Transaction ID a code identifying the processing of the electronic payment associated with the transaction (“Payment Transaction ID”). In a typical transaction, Payment Card Interchange 2014 can assign a Payment Transaction ID to the processing of the electronic payment associated with the Retailer Transaction ID.

After receiving Retailer Transaction ID Query 2040, Retailer Server 0272 can perform a variety of steps, including, but not limited to: (a) reading the Payment Transaction ID; (b) querying the Retailer Transaction Database; (c) identifying the record including the Payment Transaction ID; (d) identifying the Retailer Transaction ID associated with the Payment Transaction ID; and/or (e) identifying within the Retailer Transaction Database or querying another database for one or more Product IDs identifying the products purchased in the transaction identified by Retailer Transaction ID.

In another embodiment, Retailer Server 0272 can assign to the transaction implementing the purchase of one or more products an ID that is the Payment Transaction ID utilized by Payment Card Interchange 2014. In that case, Retailer Server 0272 can read the Payment Transaction ID in Retailer Transaction ID Query 2040 and directly query the Retailer Transaction Database for the record identified by the Payment Transaction ID. Retailer Server 0272 can query the identified record for one or more Product IDs identifying the products purchase in the transaction identified by Payment Transaction ID.

For example, a customer can use a Payment Card XYZ 2010 to pay for a transaction to which a Retailer Server 0272 assigns a Retailer Transaction ID 1234567890. The transaction can include the purchase of one product, whose Product ID is an UPC 123456789012. In processing the electronic transaction, Payment Card Interchange 2014 or another Data Processing System can assign to the transaction implementing the processing of the electronic payment a Payment Transaction ID 1234567890. In the present example, Payment Card Interchange 2014 can transmit to Retailer Server 0272 a Retailer Transaction ID Query 2040 including the Payment Transaction ID 1234567890. Retailer Server 0272 can read from the Retailer Transaction ID Query 2040 the Payment Transaction ID 1234567890, query the Retailer Transaction Database 2220, identify the record including the Payment Transaction ID 1234567890, identify the Retailer Transaction ID 1234567890 the Retailer Server 0272 assigned to the transaction, and/or identify a product whose Product ID=123456789012, which can equal the Product ID included in the Retailer Transaction ID Query 2040.

Retailer Transaction ID Query Results 2050 can include any data representing the results of a query of any Retailer Server 0272 database for a match in the Product ID of one or more products purchased by WD/NWD User and the Product ID of one or more products promoted by an Advertiser 0220 in a Purchase Incentive.

In the preceding example, after identifying a product whose Product ID=123456789012, which equals the Product ID included in Retailer Transaction ID Query 2040, Retailer Server 0272 can write to a file any matching Product ID and any other data enabling the association of the purchase of the product with the viewing of an Advertisement promoting the product. In another embodiment, Retailer Server 0272 can write to a file any matching Product ID and any other data enabling the association of the purchase of the product with an User Request of a Purchase Incentive even if the User Request is not related to an Advertisement.

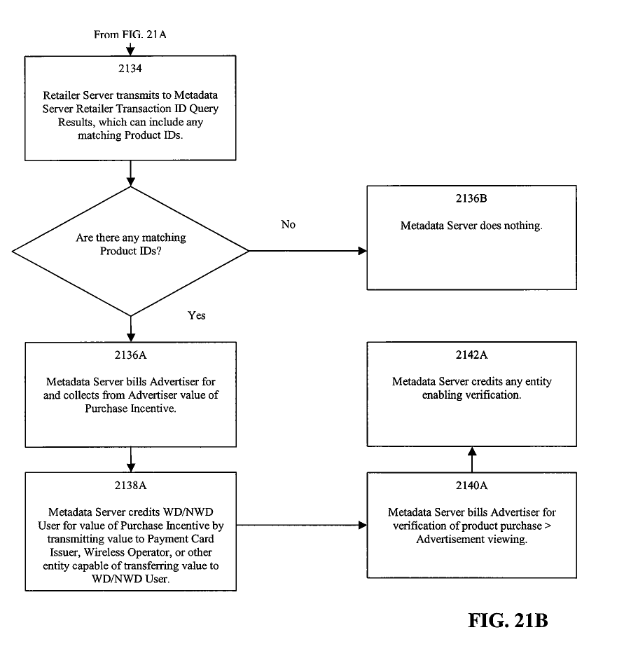

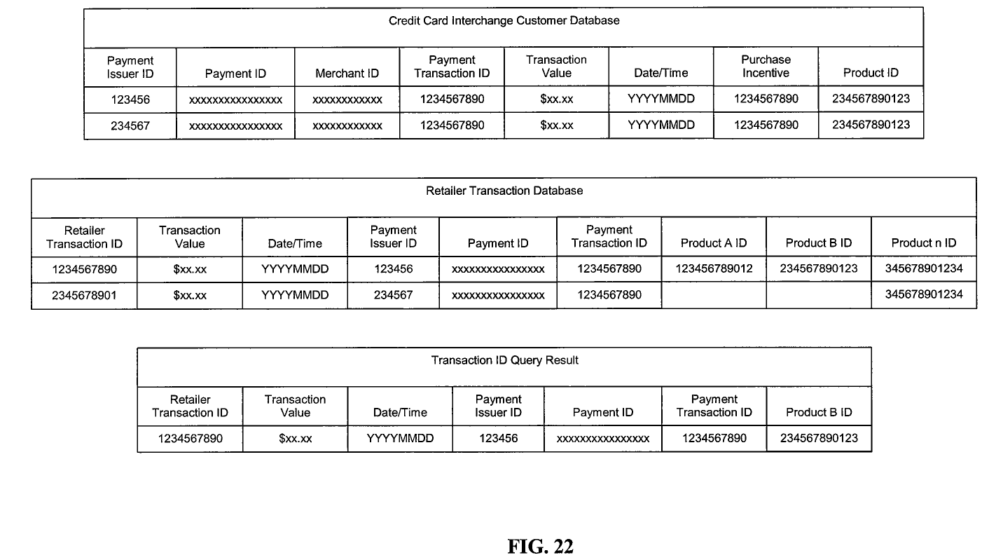

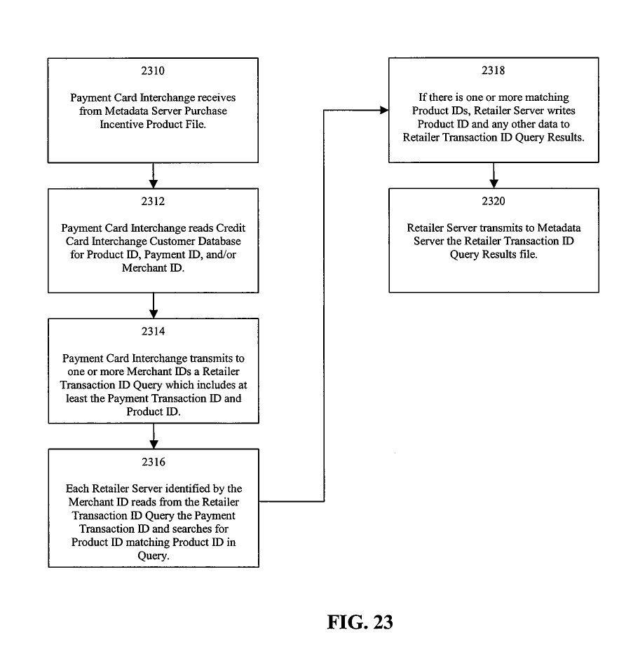

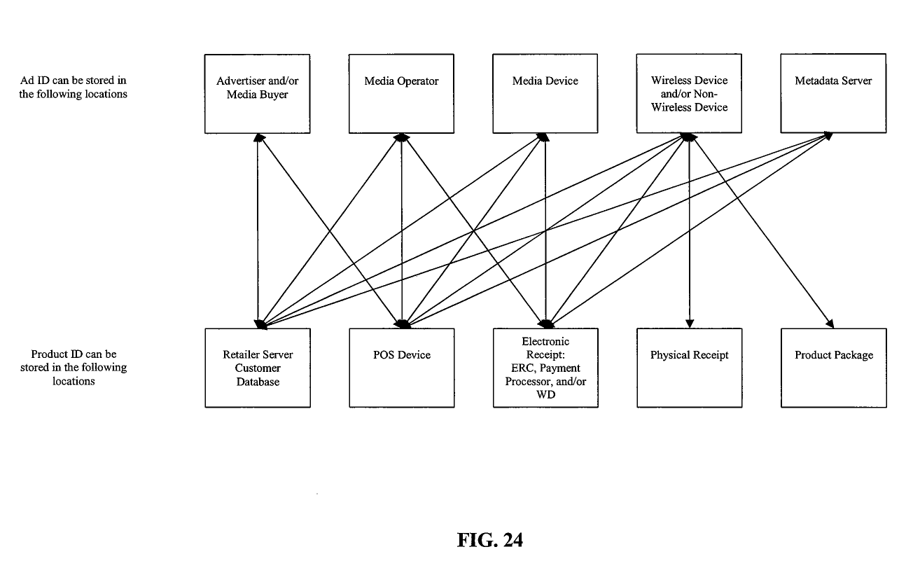

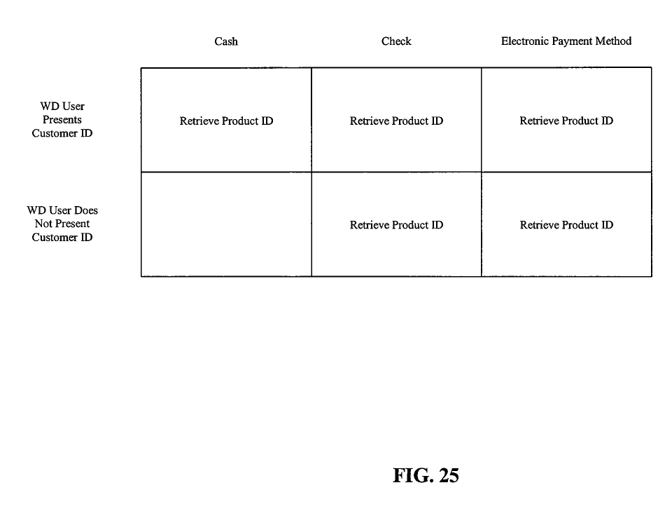

FIGS. 21A and 21B depict a flowchart of an exemplary Method 2100 for enabling the exchange of data among a variety of data processing systems to verify if a WD/NWD User purchased a product utilizing an electronic payment method. The flowchart refers to the systems and structures depicted in FIGS. 19 and 20. However, the flowchart is not limited to those embodiments. The flowchart can utilize a subset of the components, or additional, related, alternative, and/or equivalent components depicted in FIGS. 19 and 20. The flowchart can execute a subset of the steps, executing the steps in different order, and/or executing other or additional related or equivalent steps.

At 2110, Wireless Device 0210 and/or Non-Wireless Device 0410 can transmit to Metadata Server 0280 one or more Payment IDs. Because of the sensitivity of consumers to transmitting Payment IDs, a variety of alternative methods can utilize Payment IDs without requiring a WD/NWD User to transmit a Payment ID.

For example, Data Processing Systems operated by parties which most WD/NWD Users already trust can protect the security of their Payment IDs. These parties can include, but are not limited to: (a) a Wireless Operator 0240; and/or (b) a party operating a Payment Card Interchange 2014, e.g., an association of credit card issuers. Because these parties already store one or more Payment IDs issued to most WD/NWD Users, consumers generally should not have a problem with transmitting to and/or allowing those parties to utilize their Payment IDs to identify one or more products purchased. For example, these parties can operate Customer Product Purchase Database 0510 and write, process, store, and read one or more Payment IDs to and/or from Customer Product Purchase Database 0510.

At 2112, Metadata Server 0280 can write one or more Payment IDs, the Payment Card Interchange Vendor ID, and any other related data to Customer Product Purchase Database 0510.

At 2114, while or after viewing an Advertisement promoting a product of interest, WD/NWD User can transmit an User Request requesting a Purchase Incentive.

At 2116, the present method can repeat 1616 through 1622.

At 2118, when Wireless Device 0210 user enters a Physical Retailer, he/she can call Purchase Incentive Product Reminder to look up one or more products for which he/she requested a Purchase Incentive.

At 2120, POS Device 0270 can read the Product ID of at least one product for which Wireless Device 0210 user requested a Purchase Incentive (“Purchase Incentive Product”).

At 2122, Wireless Device 0210 user can transmit a Payment ID to POS Device 0270 or any I/O Device integrated with or connected to POS Device 0270. POS Device 0270 can read and transmit Payment ID to Retailer Server 0272.

At 2124, Retailer Server 0272 can process the transaction purchasing the Purchase Incentive Product. In a typical transaction, Retailer Server 0272 can perform a variety of functions, including, but not limited to: generating a Retailer Transaction ID to identify the transaction, writing the Product ID of one or more products purchased in the transaction, including Purchase Incentive Product, and/or storing the record of the transaction in a Transaction Database.

At 2126, at any time after WD/NWD User transmits an User Request, Metadata Server 0280 can transmit to one or more Payment Card Interchange 2014 vendors a Purchase Incentive Product File 2030. In Method 2100, Metadata Server 0280 does not have to transmit a Purchase Incentive Product File 2030 immediately after WD/NWD User transmits an User Request for the Purchase Incentive included in Purchase Incentive Product File 2030. In one embodiment of Method 2100, WD/NWD User can receive the value of Purchase Incentive in the form of a rebate transmitted in an invoice regularly received by WD/NWD User. For example, a Wireless Device 0210 user typically receives a regular invoice from the Wireless Operator of which he/she is a subscriber. In another example, a WD/NWD User who utilizes a Payment Card typically receives a regular invoice from Payment Card Issuer 2016. If the WD/NWD User receives the value of Purchase Incentive at the time he/she receives the regular invoice, 2126 can be implemented at any time after WD/NWD User transmits an User Request and before the transmission of the regular invoice.

At 2128, Payment Card Interchange 2014 vendor can read from Purchase Incentive Product File 2030 data including, but not limited to: Payment ID, and/or one or more Product IDs promoted by the Purchase Incentive.

At 2130, Payment Card Interchange 2014 vendor can transmit Retailer Transaction ID Query 2040 to Retailer Server 0272.

At 2132, Retailer Server 0272 can read from Retailer Transaction ID Query 2040 the Transaction ID, which Retailer Server 0272 can utilize in a query of Transaction Database to identify any Product ID in Transaction Database matching a Product ID in Retailer Transaction ID Query 2040.

At 2134, Retailer Server 0272 can transmit to Metadata Server 0280 Retailer Transaction ID Query Results 2050, which can include any matching Product IDs.

If there are no matching Product IDs in a Retailer Transaction ID Query Results 2050 received from one or more Retailer Servers 0272, Metadata Server 0280 can conclude that WD/NWD User did not purchase the product promoted by the Purchase Incentive. In that event, Metadata Server can take no action in 2136B.

If there is at least one matching Product ID in a Retailer Transaction ID Query Results 2050 received from one or more Retailer Servers 0272, Metadata Server 0280 can conclude that WD/NWD User purchased the product promoted by the Purchase Incentive. In that event, at 2136A, Metadata Server 0280 can bill Advertiser 0220 and/or Media Buyer 0222 for and collect from Advertiser 0220 and/or Media Buyer 0222 the value of Purchase Incentive.

At 2138A, Metadata Server 0280 can credit WD/NWD User for the value of Purchase Incentive by transmitting the Purchase Incentive value to Payment Card Issuer 2016, Wireless Operator 0240, and/or any other entity capable of transferring value or crediting WD/NWD User. Any method can transfer value to and/or credit WD/NWD User.

At 2140A, Metadata Server 0280 can bill Advertiser 0220 and/or Media Buyer 0222 for verifying the purchase of the product promoted in an Advertisement viewed by WD/NWD User.

At 2142A, Metadata Server 0280 can credit any entity enabling the verification.

In another embodiment, Method 2100 can enable the matching of the Product ID in a Purchase Incentive with the Product ID in a Customer Database operated by a Retailer which did not issue the WD/NWD User a Shopper Loyalty ID.

### 9.1 Identification of Advertisement_{CAUSE}

If a WD/NWD User transmits an User Request which includes a Command requesting a Purchase Incentive within the time period specified in the Advertisement, then the time period for searching Advertisement_{CAUSE} can be limited to that time period, e.g., 15 minutes. The benefits of limiting the time period in which a WD/NWD User transmits an User Request requesting a Purchase Incentive can include, but are not limited to: encouraging WD/NWD Users to view Advertisements; and/or increasing the ability of identifying a causal relationship between an Advertisement and a subsequent purchase of the product promoted in the Advertisement.

### 6. CONCLUSION

While the present application has described various embodiments, it should be understood that they have been presented by way of example only, and not limitation. Various changes in form and detail can be made therein without departing from the spirit and scope of the invention. Thus, the breadth and scope should not be limited by any of the above-described exemplary embodiments, but should be defined only in accordance with the following claims and their equivalents.

The present application includes headings herein for reference and to aid in locating certain sections. The present application does not intend these headings to limit the scope of the concepts described therein. The present application may apply the concepts in other sections throughout the entire specification.

While the present application describes how to format data, input commands, keywords/keyphrases, or any other values, assign names to variables, and assign names to values that are written and/or spoken in the English language, the data, inputs, variables, and values can be written and/or spoken in alternative languages. Modification of the systems, methods, apparatuses, and/or computer program products can operate with data, inputs, variables, and values in languages different from English.

Reference to “invention” herein refers to one or more embodiments and is not intended to limit the scope of the claims to the description following the phrase.

What is claimed is:

1. A method, comprising:
receiving product purchase data associated with a customer;
receiving at least one purchase incentive parameter value associated with a product;
associating the customer with a customer category based on the product purchase data; and
defining a purchase incentive for the product based on the customer category and based on the at least one purchase incentive parameter value.

2. The method of claim 1, wherein the product purchase data originates at a retailer.

3. The method of claim 1, wherein the product purchase data originates at a wireless communication device.

4. The method of claim 1, wherein the at least one purchase incentive parameter value includes at least one of a discount parameter value, a volume parameter value, or an expiration parameter value.

5. The method of claim 1, wherein the customer category is at least one of a new to product customer category, a loyal to competitor product category, or a loyal to vendor product category.

6. The method of claim 1, wherein the customer category is a first customer category mutually exclusive with a second customer category.

7. The method of claim 1, wherein the defining includes defining dynamically in response to a request from a retailer.

8. The method of claim 1, wherein the defining includes defining independent of data obtained via a search engine.

9. The method of claim 1, further comprising:
sending an indicator related to the purchase incentive to an entity associated with a point of sale device.

10. A method, comprising:
receiving a customer identifier associated with a customer;
receiving purchase data associated with the customer based on the customer identifier; and
calculating a parameter value of a purchase incentive based on a financial condition and based on the customer identifier, the parameter value of the purchase incentive being sent to a point of sale device in response to a transaction associated with the customer identifier.

11. The method of claim 10, wherein the financial condition is defined based on at least one of a revenue, a gross margin, or a profit.

12. The method of claim 10, wherein the customer identifier is associated with a vendor.

13. The method of claim 10, wherein the receiving includes receiving in response to a user-triggered interaction with a wireless communication device.

14. The method of claim 10, wherein the calculating includes calculating in response to a user-triggered interaction with a wireless communication device.

15. The method of claim 10, wherein the parameter value of the purchase incentive is stored at a server until the transaction is performed.

16. The method of claim 10, wherein the parameter value is a financial value.
